(19) United States
(12) Patent Application Publication
(10) Pub. No.: US 2015/0046183 A1
(43) Pub. Date: Feb. 12, 2015

(54) REMOTE, VIRTUAL PHYSICAL EXAM ACQUISITION AND DISTRIBUTION

(71) Applicant: James V. Cireddu, Brecksville, OH (US)

(72) Inventor: James V. Cireddu, Brecksville, OH (US)

(21) Appl. No.: 13/964,805

(22) Filed: Aug. 12, 2013

(51) Int. Cl. G06F 19/00

(52) U.S. Cl. CPC G06F 19/322
USPC 705/3

(57) ABSTRACT

Remote, virtual physical examinations can be performed, wherein a patient and a healthcare provider are not in the same physical location. The identity of the patient can be obtained and verified. A set of instructions related to the physical examination are provided to the patient. The set of instructions are configured to be reproducible across patients and over the course of a patient's medical history (e.g., physical exams occurring at different times). As health data is ready to be captured, the health data is visually recorded and/or audibly recorded. After completion of the physical examination, the patient data can be conveyed to the remote healthcare provider.

### TECHNICAL FIELD

The subject disclosure relates generally to remote, virtual physical exam acquisition and distribution.

### BACKGROUND

The healthcare industry has been reported to be one of the world's largest and fastest growing industries. Healthcare can also be a large portion of a country's economy. Although it might seem as if patient care effectiveness is on the decline, healthcare costs continue to rise. While more money is spent on healthcare per person in the United States than in any other nation in the world, in 2009 the United States Census Bureau reported that 16.7% of the population was uninsured. Current estimates place United States healthcare spending at approximately 16% of gross domestic product. Growth in healthcare spending is projected to average about 6.7% annually over the period 2007 through 2017. High healthcare costs affect individuals. A 2007 study (the most recent available) found that 62.1% of bankruptcy filers cited high medical expenses as a contributing factor.

Review, documentation, historical analysis, and physical examination are fundamental requirements of healthcare providers and provides for the development of an assessment and treatment plan. Healthcare providers can review patients' electronic medical records, vital signs, electrocardiograms, laboratory results, and imaging remotely, through “telemedicine”. However, for the physical examination, the healthcare provider must be in physical contact with the patient.

### SUMMARY

The following presents a simplified summary in order to provide a basic understanding of some aspects described herein. This summary is not an extensive overview of the disclosed subject matter. It is intended to neither identify key nor critical elements of the disclosure nor delineate the scope thereof. Its sole purpose is to present some concepts in a simplified form as a prelude to the more detailed description that is presented later.

An aspect relates to a system comprising a memory and a processor coupled to the memory. The memory stores instructions and the processor executes computer executable components stored in the memory. The computer executable components include a verification manager component that obtains and verifies an identity of a patient and an instruction manager component that outputs a set of directions related to capturing a plurality of health data associated with the patient. The plurality of health data relates to a remote physical examination of the patient. The computer executable components also include a capture component that receives an indication that at least one health data of the plurality of health data is available and records the at least one health data. Further, the computer executable components include a communication component that establishes a communication link between the patient and a healthcare provider and transmits the at least one health data over the communication link. The patient is located remotely from the healthcare provider.

Another aspect relates to a method that includes verifying, by a system comprising a processor, identification information indicative of an identity of a patient and providing, by the system, a set of directions related to capturing a plurality of health data associated with the patient. The plurality of health data relates to a remote physical examination of the patient. The method also includes capturing, by the system, the plurality of health data based on an indication that the plurality of health data is ready to be captured. Further, the method includes communicating, by the system, the plurality of health data to a healthcare provider. The healthcare provider and the patient are located in disparate locations.

A further aspect relates to a computer-readable storage device storing computer-executable instructions that, in response to execution, cause a system comprising a processor to perform operations. The operations include outputting a set of directions related to capturing a plurality of health data associated with a patient. The plurality of health data relates to a remote physical examination of the patient. The operations also include receiving an indication that at least one health data of the plurality of health data is available and recording the at least one health data in a visual format, an audible format, or both a visual format and an audible format. Further, the operations include establishing a communication link between the patient and a healthcare provider and transmitting the at least one health data over the communication link, wherein the patient is located remotely from the healthcare provider.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Various non-limiting embodiments are further described with reference to the accompanying drawings in which:

FIG. 1 illustrates an example, non-limiting system configured for remote physical exam acquisition, according to an aspect;

FIG. 2 illustrates an example, non-limiting embodiment of a system configured to acquire patient examination details from a remote location, according to an aspect;

FIG. 3 illustrates an example, non-limiting embodiment of a system for performing a remote physical examination of a patient, according to an aspect;

FIGS. 4-8 illustrate a series of display prompts that instruct a patient/onsite caregiver on performing a remote, virtual physical examination, according to an aspect;

FIG. 9 illustrates an example of a welcome screen that might be presented to a healthcare provider, according to an aspect;

FIG. 10 illustrates an example, non-limiting representation of a display that can be accessed by the healthcare provider to select various portions of the remote, virtual examination for review, according to an aspect;

FIG. 11 illustrates an example, non-limiting system for performing physical examinations, according to an aspect;

FIG. 12 illustrates an example, non-limiting method for virtual physical examinations, according to an aspect;

FIG. 13 illustrates another method for performing a remote physical examination, according to an aspect;

FIG. 14 illustrates an example, non-limiting method of a remote physical examination, according to an aspect;

FIG. 15 is a schematic example wireless environment that can operate in accordance with aspects described herein;

FIG. 16 illustrates a block diagram of access equipment and/or software related to access of a network, in accordance with an embodiment; and

FIG. 17 illustrates a block diagram of a computing system, in accordance with an embodiment.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Multiple industries have emerged around the needs of overworked healthcare providers and chronically short-staffed healthcare provider facilities and groups. Technology increasingly offers opportunities to meaningfully address the barriers to patient care effectiveness and reduce the cost of healthcare. For example, improved communications systems, as discussed herein, allow healthcare providers to connect with patients across distances. Further, electronic health records (EHRs) enhance the portability and accessibility of patients' medical histories. Review and documentation of a history and physical examination is a fundamental requirement of a healthcare provider and allows for the development of an assessment and treatment plan. Despite these opportunities, telemedicine systems have failed to address existing medical requirements, including providing remote healthcare providers access to complete histories and physical examinations to be efficiently reviewed and acted upon by clinicians.

The disclosed aspects address the above noted issues, as well as other issues, by allowing healthcare providers to access a patient remotely. The disclosed aspects can be configured to unburden the need for a healthcare provider to be in physical contact with a patient and utilizes digital audio and video recording guided and organized aspects for remote review by the healthcare provider. Another objective of the various aspects is to facilitate professional healthcare and consulting services in order to provide efficient review of the patient history and allow secure telecommunications between the patient and the remote healthcare provider.

As used herein, the terms “remote healthcare”, “remote medicine”, “telehealth”, “telemedicine” and the like might be used interchangeably depending on the context. Such terms refer to the practice of healthcare delivery, diagnosis, consultation, treatment, transfer of medical data, and/or education using interactive audio, video, and/or data communications with a patient, a caregiver, or a healthcare provider. The term “interactive” as used herein refers to audio, video, and/or data communication involving real-time (e.g., synchronous) or near real-time (e.g., asynchronous), or at different times, two-way communication or transfer of data and/or information. The term “remote” as used herein refers to a healthcare provider who is not present with a patient at the time the healthcare services are rendered, through the use of the various aspects disclosed herein.

The disclosed aspects provide for the extension of patient care effectiveness of a primary healthcare provider, group, or individual. In an implementation, a technician or caregiver can be directed to obtain key physical examination data, including auditory and video data, for storage or distribution to a remote location. The key physical examination data can be reviewed immediately, or substantially immediately, for review. According to another implementation, the key physical examination data can be retained (e.g., stored in a memory or database) for later review. In a further implementation, the key physical examination data can be added to historical data for the patient.

According to an aspect, a remote electronically obtained virtual physical examination can be performed and, when combined with associated electronic historical data, can allow healthcare providers to effectively care for patients in remote and/or underserved locations, which can improve access to healthcare. Additionally, healthcare providers can have increased flexibility to care for patients at the patient's home, at skilled nursing facilities, at long-term acute care facilities, during hospitalization, and at other locations (e.g., at the scene of an accident, at the site of a medical emergency, and so on), without the need for the healthcare provider to physically travel to the patient's location. Further, home care visits by visiting nurses can be supplemented by healthcare provider oversight utilizing the disclosed aspects. Further, a thorough virtual physical exam and history can allow healthcare providers to charge patients for appropriate levels of care, which can remotely open up new opportunities for primary care and consultants.

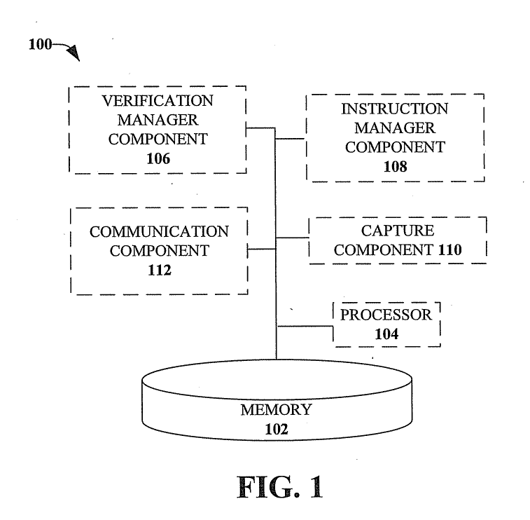

Referring initially to FIG. 1, illustrated is an example, non-limiting system 100 configured for remote physical exam acquisition, according to an aspect. System 100 comprises at least one memory 102 that can store computer executable components and instructions. System 100 can also include at least one processor 104, communicatively coupled to the at least one memory 102. Coupling can include various communications including, but not limited to, direct communications, indirect communications, wired communications, and/or wireless communications. The at least one processor 104 can facilitate execution of the computer executable components stored in the at least one memory 102. The at least one processor 104 can be directly involved in the execution of the computer executable component(s), according to an aspect. Additionally or alternatively, the at least one processor 104 can be indirectly involved in the execution of the computer executable component(s). For example, the at least one processor 104 can direct one or more components to perform the operations.

It is noted that although one or more computer executable components may be described herein and illustrated as components separate from the at least one memory 102 (e.g., operatively connected to memory), in accordance with various embodiments, the one or more computer executable components could be stored in the at least one memory 102. Further, while various components have been illustrated as separate components, it will be appreciated that multiple components can be implemented as a single component, or a single component can be implemented as multiple components, without departing from example embodiments.

System 100 includes a verification manager component 106 that can be configured to identify a patient and verify the accuracy of the identification. For example, the verification manager component 106 can interface or communicate with the patient or another person that is with the patient during the physical examination. As used herein, “onsite patient caregiver” or “onsite caregiver” refers to a person that has an interest in, or a responsibility for, the health and welfare of a patient and is present with the patient at least once, intermittently, often, or full-time. Non-limiting examples of onsite caregivers include a spouse, children, extended family members, friends, employees, nurses, hospice workers, emergency medical technicians, paramedics, police officers, firefighters, primary caregiver, and so on.

In an example, the verification manager component 106 can receive an input (e.g., typing on a keyboard or number pad, voice information, and so on) that includes identifying information of the patient. Such identifying information can include the patient name, social security number, medical record number, date of birth, insurance member number, and so on. Additionally or alternatively, the verification manager component 106 can include, or be operatively connected to, one or more cameras or one or more scanners, which can scan a bar code (e.g., a matrix barcode, a two-Dimensional barcode (sometimes referred to as a quick response code, or other types of barcodes). In another example, the verification manager component 106 can be configured to scan or receive biometric data (e.g., face recognition, fingerprint, iris recognition, DNA, and so on).

Also included in system 100 is an instruction manager component 108 that can be configured to direct the patient (or onsite caregiver) to electronically record a physical examination, which can be a complete physical examination and/or a limited or localized physical examination. The directions provided by the instruction manager component 108 can be in a step-wise (e.g., step-by-step) manner. Further, the directions can be dynamically modified, depending on whether the physical examination is to be a comprehensive examination or a focused examination limited to a specific medical condition. The determination of whether the examination is to be comprehensive or focused can be based on one or a number of factors including the purpose for the examination (e.g., yearly checkup, treatment for specific symptoms, and so on) and/or observations during the examination (e.g., rashes, swelling, irregular heartbeat, and so forth).

Also included in system 100 can be a capture component 110 that can be configured to record one or more visual representations or audible representations of the patient. For example, if sounds of the lungs, heart, and so on are to be captured, the patient/onsite caregiver applies a device (e.g., stethoscope, microphone) at the appropriate location and indicates the device is ready (e.g., by pressing a button, speaking a verbal command, and so on).

The capture component 110 can be an electronic device that is in the same location as the patient. For example, the capture component 110 might be a device owned by the patient or owned by someone else (e.g., a neighbor, a family member, a friend, and so forth) and accessible to the patient, a device that is sent to the patient prior to the examination, a device that is brought to the patient location by someone, and so forth. According to an implementation, the capture component 110 can be included, at least partially, on one or more disparate medical devices. In some embodiments, the capture component 110 is a portable imaging device. In other embodiments, the capture component 110 is a portable auscultation device.

According to some aspects, the capture component 110 can be configured to measure (automatically or based on interaction with the patient/onsite caregiver) one or more of the patient's vital signs and/or other biometrics. The vital signs and/or biometrics can include, but are not limited to, one or more of: body temperature, heart rate, blood pressure, respiratory rate, blood diagnostics such as oxygen saturation, glucose concentration, and blood count, urine diagnostics such as specific gravity, protein, glucose, and blood, other bodily fluid diagnostics, and a diagnostic image or imaging report.

In an example, the capture component 110 can be paired with a variety of medical devices. Such medical devices include, but are not limited to, electronic stethoscopes (e.g., Bluetooth stethoscopes), thermometers, blood pressure monitor, and so on. In another example, the medical device can be a biometric sensor, a portable imaging device, a portable auscultation device, as well as other devices. The capture component 110, according to some implementations, can be a wired device or a mobile device owned by the patient or another individual. A mobile device can also be called, and may contain some or all of the functionality of a system, subscriber unit, subscriber station, mobile station, mobile, wireless terminal, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a feature phone, a wireless local loop (WLL) station, a personal digital assistant (PDA), a laptop, a handheld communication device, a handheld computing device, a netbook, a tablet, a satellite radio, a data card, a wireless modem card and/or another processing device for communicating over a wireless system and/or a wired system.

According to an implementation, the instruction manager component 108 can be configured to guide the patient/onsite caregiver to one or more appropriate auscultation sites on the patient's body. In an example, the instruction manager component 108 can instruct the patient/onsite caregiver to use a stethoscope to detect the heartbeat at a particular location (or multiple locations) on the patient's body. In this case, the stethoscope can be utilized as the capture component 110 or can be operatively connected (e.g., wired or wireless) to the capture component 110.

The captured information can be transmitted to the healthcare provider by a communication component 112. The communication component 112 can be configured to create and maintain a communication link between the patient/onsite caregiver and the healthcare provider. For example, the communication link can be over the Internet, and can include phone and/or videoconference. According to an implementation, the communication link can be a secure telecommunication link.

The communication link can be utilized to receive the patient exam information at the healthcare provider's location (or the locations of multiple healthcare providers), wherein the healthcare provider(s) and the patient are located at disparate locations. In an example, the healthcare provider and patient can be located in the same city or in neighboring cities, however, due to various circumstances (e.g., a homebound patient, inconvenience for the patient, to minimize costs (e.g., eliminate a facility fee), and so on), the patient does not desire to (or physically cannot) travel to the healthcare facility. In accordance with some aspects, the patient and healthcare provider can be located in different counties, different states, and even different continents. It is also contemplated that the patient or the healthcare provider might be traveling in an aircraft, or spacecraft (e.g., space tourism), and the like. It is also contemplated that one or more people might be located at sea (e.g., on a cruise ship, on a submarine (e.g., military personnel), and so forth) or underground (e.g., in a mine, such as a salt mine or a coal mine). Thus, the patient and/or healthcare provider can be located anywhere, provided a communication link is enabled (e.g., through the communication component 112) and can transmit information, through wired means, wireless means, or a combination of wired means and wireless means. For example, a patient and healthcare provider might have an ongoing relationship and, instead of the patient having to work with a new healthcare provider (e.g., due to a move, a medical condition while on vacation, or other situations), the patient can continue working with the established healthcare provider.

Upon receipt of the medical data, the healthcare provider can review the information provided, as well as historical medical related information associated with the patient. According to an implementation, the examination can be performed in near-real time. For example, the healthcare provider can be actively receiving the patient information at about the same time as the information is being captured and transmitted at the patient side. During this interaction, the communication component 112 can be configured to allow the healthcare provider and patient to communicate in a real-time (or almost real-time) manner. Various manners of communication can include, but might not be limited to, telephone, push-to-talk, audio conference, video conference, text message, short message service (SMS), multimedia messaging service (MMS), instant message, Internet bulletin board, blog, microblog, fax, Internet fax, electronic mail, Voice over Internet Protocol (VoIP), and so on.

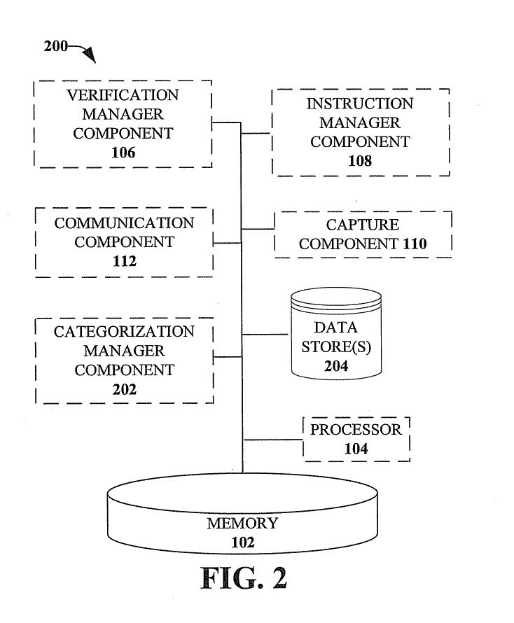

FIG. 2 illustrates an example, non-limiting embodiment of a system 200 configured to acquire patient examination details from a remote location, according to an aspect. The one or more disclosed aspects relate to a remote healthcare application that includes electronic healthcare records that can be historic records and/or live (e.g., current) records.

Remote, virtual physical examinations can be performed, wherein a patient and a healthcare provider are not in the same physical location. The various aspects virtually bring the healthcare provider to the patient and vice versa. The identity of the patient can be obtained and verified. A set of instructions related to the physical examination are provided to the patient. The set of instructions are configured to be reproducible across patients and over the course of a patient's medical history (e.g., physical exams occurring at different times). As health data is ready to be captured, the health data is visually recorded and/or audibly recorded. After completion of the physical examination, the patient data can be conveyed to the remote healthcare provider.

According to an implementation, the instruction manager component 108 can guide the patient to obtain video of physical exam findings and direct the patient/onsite caregiver to perform physical exam maneuvers that can be recorded by an audio and video recording device (e.g., capture component 110). The video information can be mapped to the patient (e.g., patient's historical data) by the categorization manager component 202. According to an implementation, based on the captured information, the categorization manager component 202 can assign auditory files to these anatomic locations.

For example, the mapping performed by the categorization manager component 202 can include providing a cross-reference between the video (and/or audio) information and the patient, the day/time of the examination, as well as other information associated with the examination (e.g., symptoms, other captured information, and so on). In another example, the mapping comprises associating a newly captured set of data with historical data associated with the same or similar type of data.

The categorization manager component 202 can also be configured to electronically record the patient's history, which can include the location, quality, severity, duration, timing, context, modifying factors, associated signs and symptoms, as well as a complete review of symptoms, past medical history, past surgical history, family history, social history, allergies, active medication list, and so on. The electronic historical data can be integrated into the examination through a combination of text insertion and audio recordings, which can include the use of voice recognition. Further, a directed history of related questions can be provided, which can depend upon prior keywords.

Upon completion of the physical examination (or during the physical examination), the data can be encrypted and organized for upload for storage on a server or for immediate broadcast to a healthcare provider and/or another individual or system (e.g., the patient, the patient's caregiver, a hospital, a primary care physician, and so on) by the communication component 112. According to some aspects, the results of the remote physical examination (e.g., electronic history and physical examination recordings) can be incorporated into the patient's electronic healthcare record.

Also included in system 200 is a data store 204 (or more than one data store), which can be communicatively coupled to the at least one memory 102 in some aspects, or can be integrated with the at least one memory 102 in other aspects. According to an aspect, the data store 204 can be configured to retain information derived from the physical examination. Further, the physical examination information can be mapped to the particular patient based, at least in part, on the patient identification performed by the verification manager component 106. According to some aspects, the physical examination information can be retained in a remote location, such as in a data store located remote from the patient and/or remote from the healthcare provider. For example, the physical examination information can be retained by one or more devices of a third party provider or, for example, in the cloud.

Maintaining the data by a third-party provider can allow the patient and/or healthcare provider portability. For example, the patient might decide to change physicians and the new physician can access the patient's medical history from the third party provider. In another example, the physician might change jobs, but might be retaining all (or a subset) of his patients. After the new job has started, the physician can access his patient's data through interaction with the third party provider. Such access would not be available after the job change if the patient data were maintained by the healthcare facility.

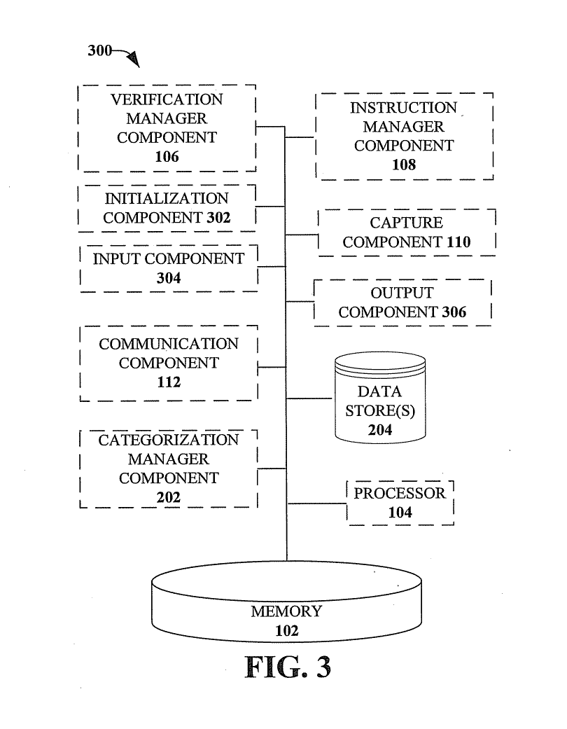

FIG. 3 illustrates an example, non-limiting embodiment of a system 300 for performing a remote physical examination of a patient, according to an aspect. The disclosed aspects are configured to extend patient care effectiveness of a healthcare provider facility, group, or individual. The disclosed aspects are also configured to provide triage services, as needed. In some embodiments, the remote care, answering, and/or professional triage services are provided in real-time. In other embodiments, the remote care, answering, and/or professional triage services are provided after a time delay.

System 300 includes an initialization component 302 that can be configured to establish a remote physical examination. According to an implementation, the initialization component 302 can receive an indication from the patient/onsite caregiver to begin the remote physical examination. The patient/onsite caregiver can interact with the initialization component 302 to indicate the desire to begin the examination. For example, an input component 304 can be associated with the initialization component 302 (as well as other components of the system 300). The patient/onsite caregiver can begin the examination by, for example, opening an application on their communications device and entering a command to initiate the examination. The exam can be initiated by answering a prompt such as “Would you like to start a new examination?”, “Would you like to continue an already started examination?”, or another type of prompt, such as a button (e.g., virtual button) that is labeled “examination” and where selecting the button initiates a new examination (e.g., executing the application on the communications device). However, other manners of beginning the examination can be utilized with the disclosed aspects, including voice commands.

In another implementation, the remote physical examination can be established by a remote healthcare provider (e.g., physician, healthcare provider facility, group, or individual). For example, the remote healthcare provider can sign-on to a communications device (e.g., computer, mobile phone, and so on) and indicate that the healthcare provider is ready for the examination. For example, the healthcare provider might be doing a series of examinations and, after finishing a first patient, initiates an examination with a second patient. The healthcare provider can initiate the examination through input component 304 (or a second or subsequent input component associated with system 300), according to an implementation. For example, a portion of system 300 can be located at the patient-side and another portion of the system 300 can be located at the healthcare provider side.

According to some implementations, the input component 304 can provide a graphical user interface (GUI), a command line interface, a speech interface, Natural Language text interface, and the like. For example, a GUI can be rendered that provides a user with a region or means to load, import, select, read, and so forth, various requests and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed. Thus, it might be inferred that the user did want the action performed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. According to some implementations, the command line interface can be employed in connection with a GUI and/or application programming interface (API). In addition, the command line interface can be employed in connection with hardware (e.g., video cards) and/or displays (e.g., black and white, and EGA) with limited graphic support, and/or low bandwidth communication channels.

According to some aspects, verification manager component 106 (or a second verification manager component) can be configured to authenticate the healthcare provider's identity. Such authentication can be based upon a user identification/password pair, or other criteria utilized to verify the identity of the healthcare provider (e.g., biometric data, voice recognition, and so on).

In some embodiments, the healthcare provider can be an adjunct healthcare provider. As used herein, the term “adjunct” refers to a healthcare provider that is credentialed by a licensed primary healthcare provider facility, group, or individual to provide remote care for one or more patients who are under the care of the primary provider. According to some implementations, the adjunct healthcare provider can be a physician and/or a non-physician. According to other implementations, the adjunct healthcare provider can be a dentist, a physician assistant, a nurse practitioner, a registered nurse, a pharmacist, a chiropractor, an emergency medical technician, a licensed practical nurse, a certified ultrasound technician, a psychologist, a social worker, a military medic, a physical therapist, an occupational therapist, a speech therapist, a radiology technician, a cardiac catheterization technician, a clinical pathology laboratory technician, a medical aesthetician, a licensed medical technologist, a toxicologist consultant, a credentialed medical legal consultant, a credentialed hospital operations administrator, and so on.

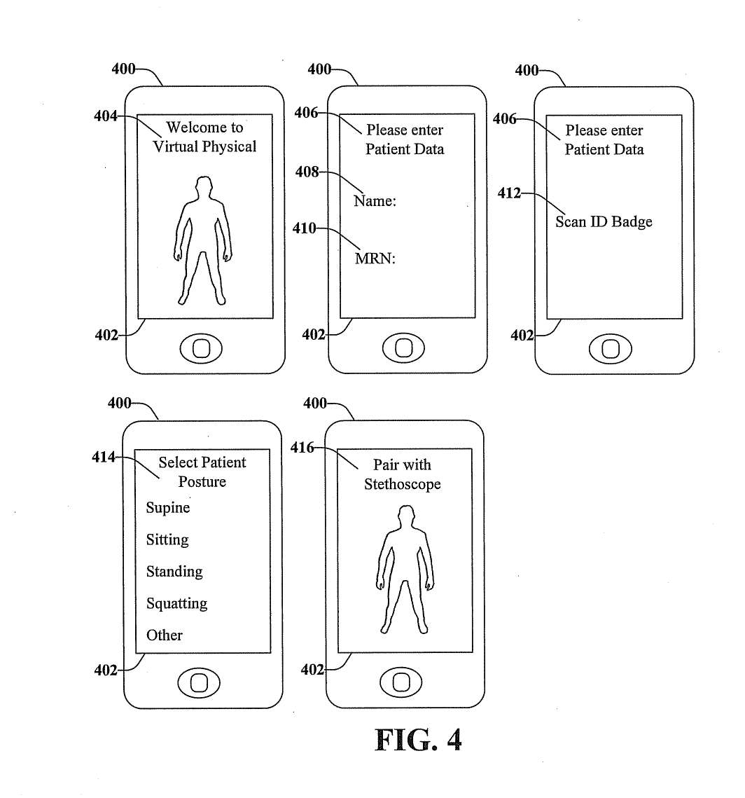

During the examination process, an output component 306 is configured to provide instructions to the patient/onsite caregiver. In an implementation, the output component 306 can provide instructions in the form of audible commands. According to some implementations; a series of video displays provides prompts (e.g., through the output component 306) and provides the patient/onsite caregiver guidance during the physical examination. By way of example and not limitation, FIGS. 4-8 illustrate a series of display prompts (associated with a software application) that instruct a patient/onsite caregiver on performing a remote, virtual physical examination, according to an aspect. Although FIGS. 4-8 illustrate and are described with reference to a smart phone 400 comprising a display screen 402, the disclosed aspects are not limited to this embodiment and other manners of communicating information can be utilized with the disclosed aspects.

At about the same time as a communication link is established, an indication can be provided that advises the parties (patient, onsite caregiver, healthcare provider) that the examination process will begin. For example, a welcome message 404 can be displayed. In another example, speakers associated with the respective devices can provide an audible greeting (e.g., “Welcome to Virtual Physical”). In accordance with some implementations, a confirmation to proceed might be needed from the patient/onsite caregiver (e.g., pressing a “Proceed” prompt on a touch screen, entering a “Yes” command on a keyboard, speaking the confirmation command, and so forth). In another example, lighting can be used to indicate the session is in process (e.g., a green light is illuminated indicating the examination is in process and other colored lighting indicates the progress of the examination).

Next, the patient data 406 is requested. In the example, a prompt for a patient name 408 and a (medical record number) MRN 410 is requested. In other examples, the patient can be identified through other means (e.g., social security number, date of birth, fingerprint, iris scan, or other biometric scan, and so on). In another example, a request to scan an ID badge 412 might be presented in order to identify the patient/onsite caregiver.

After verification of the patient identity and/or healthcare provider identity, the system might request the patient posture 414 (e.g., supine, sitting, standing, squatting, other). The appropriate posture can be input (e.g., through input component 304). The posture can be selected by highlighting the appropriate selection and pressing an enter key or through other means of selection. In some implementations, the selection is input through verbal commands. The indication of posture can be used by the healthcare provider during the examination, as different indications might be realized based on changes in posture.

In some implementations, the capture component 110 (e.g., medical device) is paired with the system 300. For example, a stethoscope might be used for a first time with the system 300 and, therefore, is paired with the system 300 to enable communication therebetween, as indicated at 416. Various means can be utilized to pair the devices, which can be through manual means (e.g., entering appropriate information related to the medical device id), such as through a series of displays (not shown) and/or verbal prompts. According to some implementations, the pairing is performed through automatic means (e.g., the medical device is automatically paired when in the vicinity of the system 300). After pairing of the one or more medical devices is completed, an indication can be provided (e.g., “stethoscope successfully paired”).

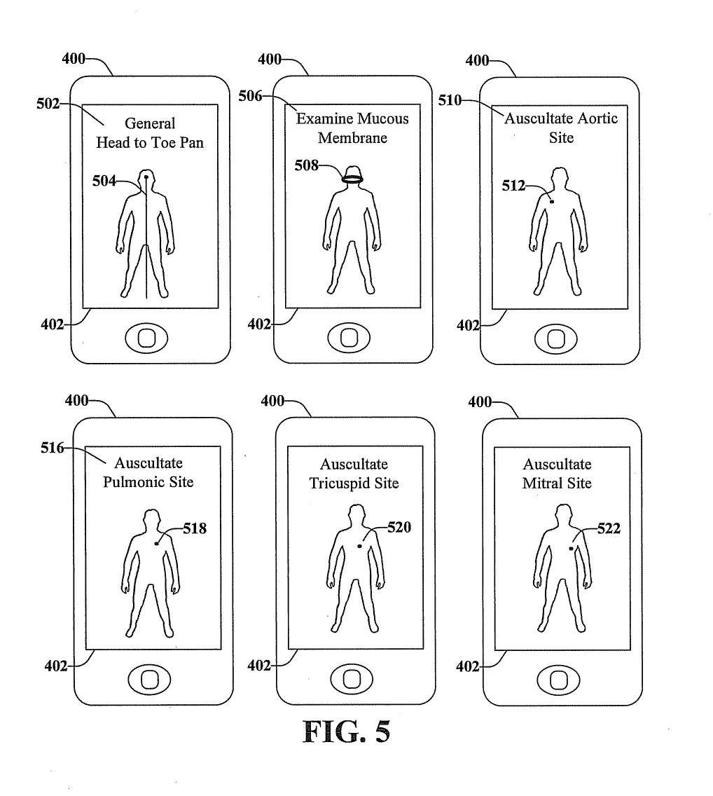

Turning now to FIG. 5, the instruction manager component 108 might next instruct the patient/onsite caregiver to perform a general head to toe pan of the patient, indicated at 502. The instructions can include, for example, a direction path, represented by line 504, so that the patient/onsite caregiver understands the direction to move the camera or other capture device. In this example, the head to toe pan comprises taking pictures or a video of the patient starting from the head and ending at the patient's feet (or vice versa). For example, a device associated with the system can be used to create a video as the patient is scanned from head to toe (or from toe to head). In some cases, the patient might be scanned from the front, back, and/or from one or both sides.

Next, the instruction manager component 108 might request examination of mucous membranes, which can include taking a picture, a series of pictures, or a video of one or more mucous membranes. In a non-limiting example, for this portion of the examination, the patient might be instructed to open his mouth so that the throat, tongue, and inside of the patient's mouth can be seen by the healthcare provider. Further to this example, the display screen 402 can display an indication of which mucous membrane is to be examined, in this case, an indication, such as circle 508, is displayed showing the mouth. The indication of the mucous membrane that is currently under examination can be represented by a circle (or other geometric shape), by a pointer (such as an illustrated arrow), by highlighting the portion of the body where the mucous membrane can be found, and so on. After the mouth is sufficiently captured (e.g., photographed), one or more other mucous membranes can be examined in a similar manner.

The instruction manager component 108 might also provide information as to locations on the patient's body to place a stethoscope, for example. As illustrated at 510, an auscultate aortic site can be examined. In order to capture a heart murmur at the appropriate location, an indication 512, is provided illustrating where on the patient's body to take this measurement. The auscultate aortic site can be measured through use of a stethoscope that is paired with the system or a stethoscope that is not paired with the system, but has an output that is amplified and able to be heard by the healthcare provider (e.g., through interaction with the system). In another implementation, the auscultate aortic site (as well as other sites) can be captured by a microphone or another device.

Continuing this example, an auscultate pulmonic site 516 can be captured and the associated indication 518 on the sample body can be output to the patient/onsite caregiver. An auscultate tricuspid site 520 and an auscultate mitral site 522 can be identified by providing respective location points on the sample body.

As recordings are captured for each site, an indication can be output to the patient/onsite caregiver that the measurement has been received. For example, the system can detect that a sound has been received and can be sufficiently reproduced for the healthcare provider. In another example, it might be determined that each measurement should be taken for a particular amount of time (e.g., ten seconds). After the amount of time has passed, the system can automatically instruct the patient/onsite caregiver to move to the next site. In a further example, a determination is made that sound has been recorded for at least a subset of the particular amount of time (e.g., for at least seven seconds out of ten seconds) before instructing the patient/onsite caregiver to proceed.

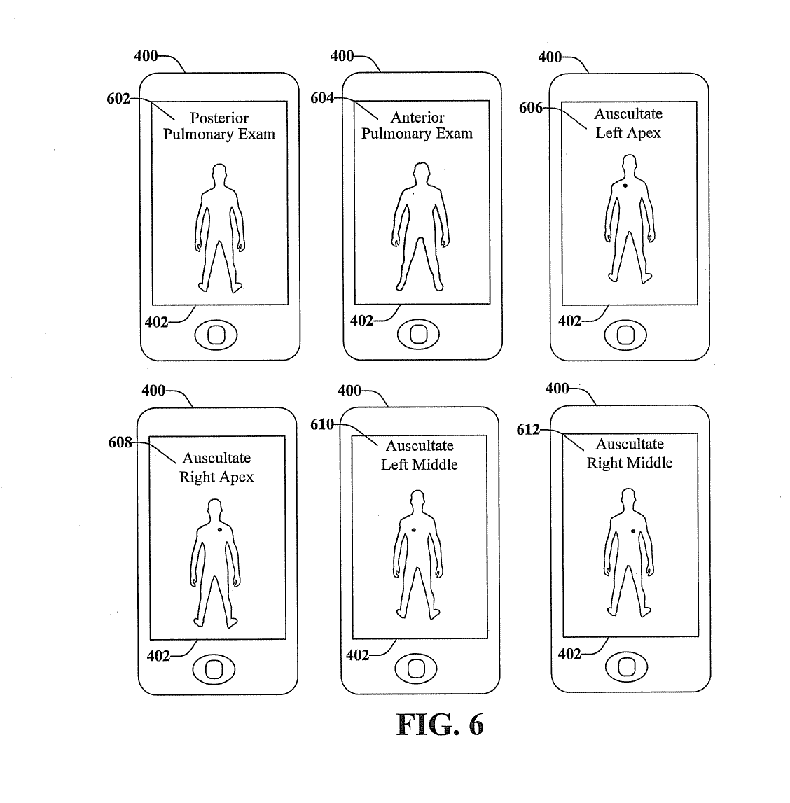

With reference now to FIG. 6, a posterior pulmonary exam 602 can be performed, wherein the sample body shows that this exam occurs on the backside of the patient. Further, an anterior pulmonary exam 604 can be performed, the sample body shows that this exam occurs on the front side of the patient.

The remote, virtual exam and series of displays can proceed with an exam of the auscultate left apex 606 and/or the auscultate right apex 608 and corresponding positioning information shown on the sample body. Further lung and/or heart sounds and murmurs, such as auscultate left middle 610 and auscultate right middle 612 can also be examined by providing instructions to the patient/onsite caregiver of the appropriate locations for these exam sites.

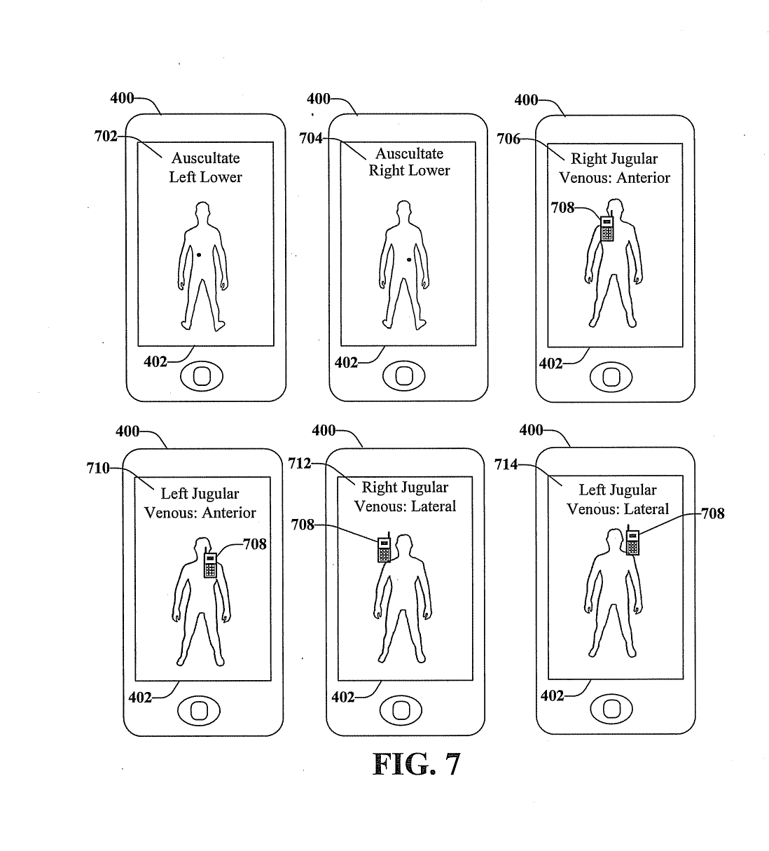

FIG. 7 illustrates further screens that can be output during the example, non-limiting remote, virtual examination. Additional heart sounds and murmurs, such as auscultate left lower 702 and auscultate right lower 704 can be captured by indicating to the patient/onsite caregiver the location where the stethoscope (or other device should be placed.

In addition to capturing heart sounds and murmurs, the patient/onsite caregiver can be instructed to capture a photo(s) or video of various locations on the patient. For example, an instruction can be to take a picture(s) or video of a right jugular venous: anterior 706. As illustrated in this example, a device 708 is illustrated at an approximate location where the picture(s)/video should be taken. Although a particular type of device is illustrated, the disclosed aspects are not limited to this device. In this case, the picture(s)/video would be of the right portion of the upper chest and neck area (e.g., including the neck veins).

The patient/onsite caregiver can also be instructed to visually capture left jugular venous: anterior 710, wherein the device 708 location on the sample body is changed to the appropriate location. Further examples include instructing the patient/onsite caregiver to visually capture the right jugular venous: lateral 712 and/or the left jugular venous: lateral 714. The picture(s)/video in this case would be the sides of the patient's neck (e.g., including the neck veins).

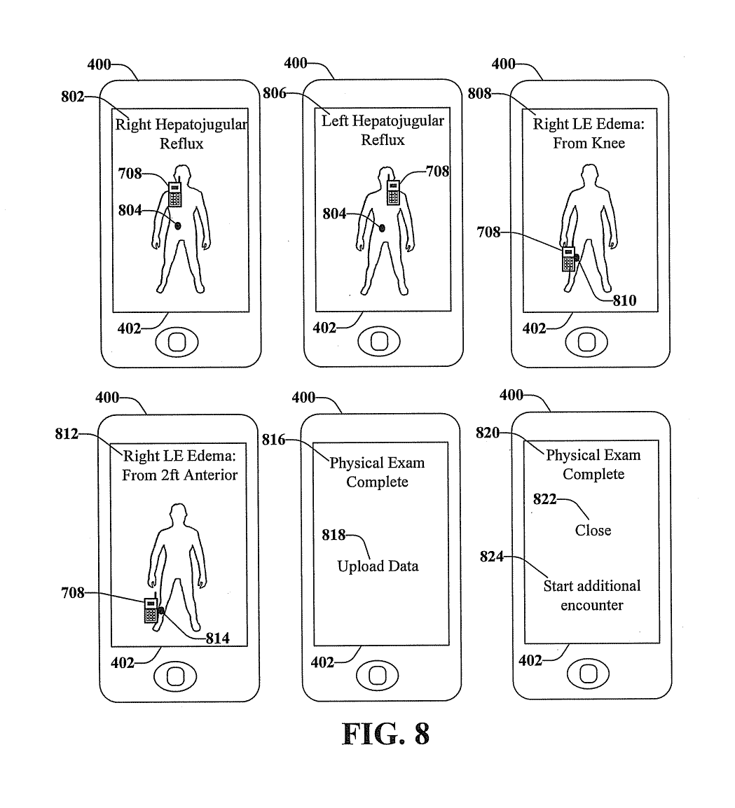

FIG. 8 illustrates further example, non-limiting examples of a series of displays that can be provided to the patient/onsite caregiver during a remote, virtual physical examination. For example, the patient/onsite caregiver can be instructed to take a photo(s)/videos of a right hepatojugular reflux 802, wherein the positioning of the device 708 is changed so that the patient/onsite caregiver can perform the task. Also provided is an indication of an area 804 where pressure should be applied on the patient. For example, the pressure can be applied by placing two or more fingers on the area 804 indicated. The photo(s)/video would include the upper right portion of the patient's body (e.g., showing the neck, with the patient's head turned to the side, and the area of the body where pressure is applied).

In a similar manner, the patient/onsite caregiver can be instructed to obtain a photo(s)/video of a left hepatojugulare reflux 806 and the appropriate area 804 where pressure should be applied is displayed. The area 804 to apply pressure is to the right upper quadrant of the abdomen, where the liver is located. The photo(s)/video would include the upper left portion of the patient's body (e.g., showing the neck, with the patient's head turned to the side, and the area of the body where pressure is applied).

Further, the patient/onsite caregiver can be instructed to take a photo(s)/video to demonstrate the right lower extremity (LE) edema 808, which can be taken from the knee, as shown by the device 708. Area 810 illustrates the location where the patient/caregiver is expected to apply pressure. For example, the lower extremity edema requires the patient/onsite caregiver to apply pressure to the shins to look for pitting edema. The captured image(s) would show the bottom portion of the patient's right leg, including the ankle, taken in a downward (relative to the ground or feet of the patient) direction. The patient/onsite caregiver is instructed to apply pressure with the index finger to the pre-tibia/shin location for five seconds, for example, to assess pretibial edema. The left LE edema can be visually captured in a similar manner.

The right LE edema 812, from 2 foot anterior, for example can also be visually captured. Area 814 illustrates the location where the patient/caregiver is to apply pressure. The captured image(s) would show the bottom portion of the patient's right leg, including the ankle from a front view. The left LE edema can be visually captured in a similar manner.

After the audio and visual details have been captured, the physical examination might be complete, which can be communicated through a display screen “Physical Exam Complete” 816. A selection can be made to upload data 818. According to some aspects, the captured data is streamed at substantially the same time as the data is captured.

After the data has been uploaded, an indication is provided that the Physical Exam is Complete 820. The application can be closed 822 or another encounter (remote, virtual physical exam) can be started 824.

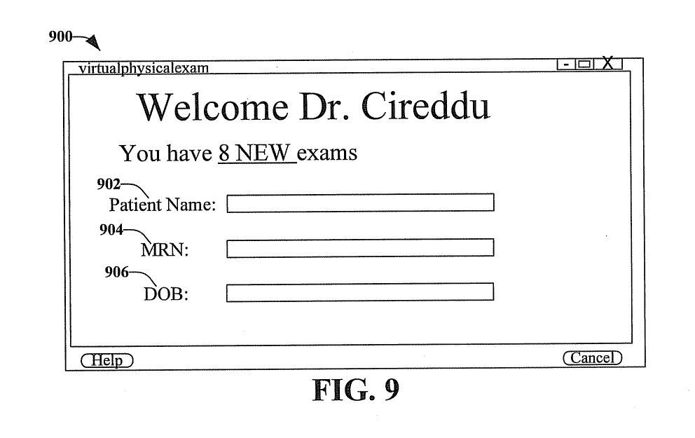

When the healthcare provider desires to review the remote, virtual examination data (or in real-time), the healthcare provider can view the uploaded information. FIG. 9 illustrates an example of a welcome screen 900 that might be presented to a healthcare provider, according to an aspect. An identity of the healthcare provider, prior to obtaining patient data, might be independently verified, according to an aspect. In some aspects, medical malpractice insurance of the healthcare provider might be verified and/or solicited.

In this example, the healthcare provider has 8 new examinations that can be reviewed. The healthcare provider can enter a patient name 902 or, according to an alternate implementation, select the patient name from a list, such as a dropdown list. Additionally or alternatively, a medical record number (MRN) 904 can be entered and/or a date of birth (DOB) 906 can be entered.

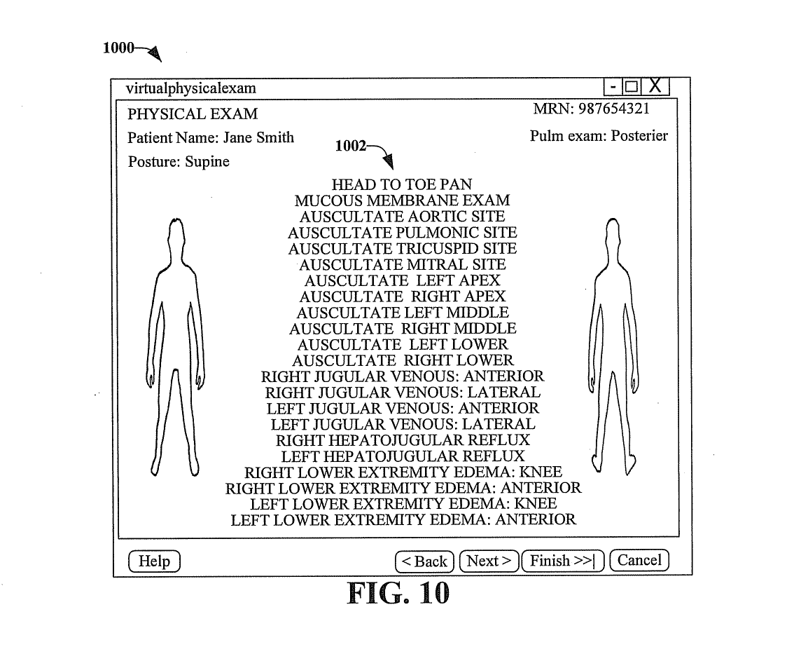

FIG. 10 illustrates an example, non-limiting representation of a display 1000 that can be accessed by the healthcare provider to select various portions 1002 of the remote, virtual examination for review, according to an aspect. The healthcare provider can step through the various portions 1002 in a linear fashion (e.g., from top to bottom of the list). According to some implementations, the healthcare provider can select each portion of the exam in any order. For example, the healthcare provider can point to one of the portions and select that portion using a mouse or keyboard interface, for example. According to some implementations, the healthcare provider can enter verbal commands to select one or more desired portions of the examination.

As the healthcare provider selects the different portions of the examination, screens related to those portions of the examination can be presented to the healthcare provider. Further, the healthcare provider can be presented with various historical information. Such historical information can include associated signs/symptoms, past medical history, past surgical history, family history, social history, allergies, active medications, and so on.

Based on the results of the remote, virtual physical examination separately, or in conjunction with the historical information, the physician can perform medical analysis of the patient. For example, the healthcare provider might order additional tests (e.g., stress test, blood work, and so on), diagnose a condition, or perform other functions with respect to the patient.

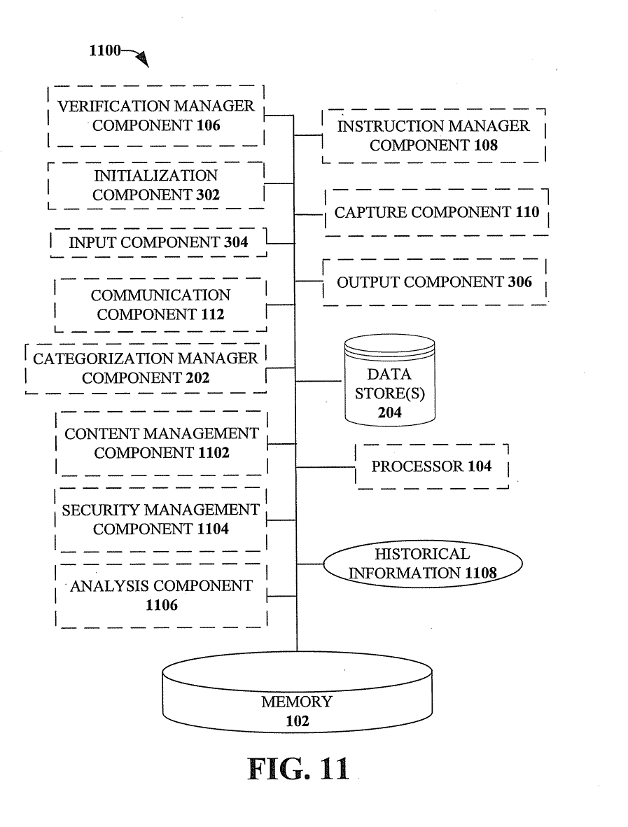

FIG. 11 illustrates an example, non-limiting system 1100 for performing physical examinations, according to an aspect. As disclosed herein, automated virtual physical examinations offer a way in which health examinations can be streamlined and physician productivity can be improved. In an example, cardiologists transitioned from performing echocardiograms themselves to allowing echo techs to perform the echocardiograms. This improved the efficiency by allowing the echo tech to complete the study. In a similar manner, the disclosed aspects allow the patient/onsite caregiver to perform the physical steps of the examination, which allows the healthcare professional to focus more on the results of the examination and perform any needed medical intervention in an efficient manner.

System 1100 is configured to perform a remote, adjunct, credentialed provider-directed healthcare examination, which can be a remote history and physical examination. Organized patient data obtained during the physical examination can be uploaded, over a communication link established between the remote adjunct provider and a patient, onsite caregiver, and/or third parties. System 1100 can further be configured to maintain compliance with data security and privacy requirements, such as through electronic encryption, for example. Further, system 1100, at a healthcare provider side, can be configured to download patient data of the electronic history and physical examination. According to some aspects, system 1100 can be included, at least partially, on two or more devices (e.g., a first device at the patient/onsite caregiver side and a second device at the healthcare provider side). According to some aspects, system 1100 is located in the cloud and peripheral devices (e.g., stethoscope, camera, display) are located on the patient/onsite caregiver side and/or healthcare provider side. According to some implementations, electronic health records (EHRs) are external to system 1100 and can comprise at least a portion of a separate electronic healthcare system.

In some embodiments, the EHRs can comprise at least one of: medical history, medication record, medication history, authenticated physical exam, laboratory test reports, imaging reports, demographics, family history, allergies, adverse drug reactions, illnesses, chronic diseases, hospitalizations, surgeries, immunization status, vital signs, age, weight, observations of daily living (ODLs), insurance benefits, insurance eligibility, insurance claim information, and billing information. In further embodiments, the EHR comprises a laboratory test report comprising at least one of: a pathology report, a blood cell count report, a blood culture report, a urinalysis report, a throat culture report, and a genetic test report. In further embodiments, the EHR comprises an imaging report comprising at least one of: an X-ray, a CT scan, a MRI, and/or an ultrasound.

According to some aspects, system 1100 can be configured to interface with more than one healthcare provider. For example, two or more healthcare providers can simultaneously, substantially simultaneously, or at different times, use the patient data obtained by the system 1100 to diagnose, consult, treat the patient, and/or perform training procedures. According to some aspects, more than one hundred healthcare providers can simultaneously, substantially simultaneously, or at different times, use the patient data obtained by the system 1100 to diagnose, consult, and/or treat the patient, and/or perform training procedures.

In accordance with some implementations, a remote, adjunct healthcare provider can be identified or selected for a particular case and/or can be contacted based on parameters including, but not limited to, a patient's condition, disease, or injury, severity of a patient's condition, disease, or injury, a patient's insurance eligibility, or availability of one or more remote, adjunct healthcare providers. By way of example and not limitation, a patient might be experiencing symptoms, which have been reviewed by a primary care physician, who would like the patient to consult a specialist. Through application of the one or more disclosed aspects, the patient data can be submitted to the specialist and the patient data can be reviewed by the specialist remotely. Based on the review, the specialist might be able to diagnose/treat the condition, determine that additional data should be obtained and/or an additional test(s) should be conducted. The initial determination can be made by the specialist remotely, which can save time and expense, and has the potential to save human life through efficient diagnosis and treatment.

Included in system 1100 is at least one memory 102 that stores instructions and at least one processor 104, coupled to the memory, that executes computer executable components stored in the at least one memory 102. Also included in system 100 is a verification manager component 106 that is configured to obtain and verify an identify of a patient. For example, the patient/onsite caregiver can enter identifying information of the patient directly through interaction with an input component 304. In another example, patient biometrics (e.g., fingerprint, iris scan, and so forth) are obtained by the input component 304. The identity of the patient can be obtained at about the same time as a remote physical examination is initiated by initialization component 302.

An instruction manager component 108 is configured to output a set of directions related to capturing a plurality of health data associated with the patient. The plurality of health data relates to a remote physical examination of the patient and comprises visual health data and audible health data. The health data can include a visual inspection of a mucous membrane, a blood pressure reading, at least one audible recording taken at an auscultation site, a photograph, or other data that can be captured, either visually or audibly or through other manners. The set of directions can be conveyed to the patient/onsite caregiver through an output component 306.

According to an implementation, the instruction manager component 108 is configured to provide the set of directions in a step wise fashion, wherein the set of directions are related to the remote physical examination of the patient. According to some implementations, the instruction manager component 108 is configured to provide the set of directions to guide the patient to one or more auscultation sites and the capture component 110 obtains a plurality of sounds associated with each of the one or more auscultation sites. Alternatively or additionally, the instruction manager component 108 can be configured to convey the set of directions as a series of video displays. Further, the instruction manager component 108 can be configured to convey the set of directions through verbal commands.

A capture component 110 can be configured to receive an indication that at least one health data of the plurality of health data is available and records the at least one health data. The capture component 110 can be paired with one or more medical devices that attain one or more health data of the plurality of health data. For example, if the patient/onsite caregiver is directed to an auscultate site, after the stethoscope or other capture device (e.g., microphone) is located at the appropriate site on the patient's body, a signal can be conveyed to system 1100 (e.g., through input component 304). The signal can be pressing an enter button, tapping an okay button on a display, or a verbal indication (e.g., “Okay”). After health data is captured, the capture component 110 can receive another indication that a subsequent health data is available and can record the subsequent health data. The communication component 112 can transmit the different captured health data over the communication link at substantially the same time. According to some implementations, the capture component 110 can be configured to electronically record communications between the patient and the onsite caregiver during the remote physical examination.

The communication component 112 can be configured to establish a communication link(s) between the patient/onsite caregiver and a healthcare provider and transmit the health data over the communication link. The patient is located remotely from the healthcare provider.

According to an implementation, a categorization manager component 202 can be configured to map each of the plurality of health data to a historical data associated with the patient. Additionally or alternatively, the health data can be retained in a data store 204.

System 1100 can also include a content management component 1102 that can be configured to manage audio and video content of communications. Content management component 1102 can also be configured to manage health record data content of communications. For example, content management component 1102 can be configured to associate the various audio and video content with the associated health data (e.g., associates a video of the patient's neck with a record that indicates it is a video of the patient's neck).

Also included in system 1100 is a security management component 1104 that can be configured to monitor the various transactions for compliance with data security and patient privacy issues. For example, one or more communication links can be established by the communication component 112. For example, multiple communication links can be created and maintained (by communication component 112) serially, or one at a time, in a patient care, answering, or triage service session. According to some embodiments, multiple communication links can be created and maintained (by communication component 112) in parallel, or simultaneously, in a patient care, answering, or triage service session. In various embodiments, communication links can enable communication through various means. For example purposes and not limitation, the communication links can be enabled through telephone, push-to-talk, audio conference, video conference, SMS, MMS, instant message, Internet bulletin board, blog, microblog, fax, Internet fax, electronic mail, VoIP, or combinations thereof. In some embodiments, one or more communication links can be interactive links and can provide real-time (e.g., synchronous) or near real-time (e.g., asynchronous) two-way communication and/or transfer of data and/or information.

According to some embodiments, the communication link(s) can be configured to allow a live, remote, adjunct healthcare provider to communicate with one or more other parties and vice versa. In some embodiments, the communication link(s) is between a live, remote, adjunct healthcare provider and a patient or a group of patients. In some embodiments, the communication link(s) can be between a live, remote, adjunct healthcare provider and an onsite patient caregiver or group of caregivers. Non-limiting examples of onsite patient caregivers include an employee of a patient, a member of a patient's family, a physician, a dentist, a physician assistant, a nurse practitioner, a registered nurse, a pharmacist, a chiropractor, a licensed practical nurse, a certified ultrasound technician, a radiology technician, a psychologist, a social worker, a physical therapist, an occupational therapist, a speech therapist, a cardiac catheterization technician, a clinical pathology laboratory technician, a medical aesthetician, a licensed medical technologist, a hospice worker, an emergency medical technician, a paramedic, a police officer, and a firefighter. In further embodiments, an onsite patient caregiver communicates with a live, remote, adjunct healthcare provider on behalf of a patient and/or to describe the condition of the patient.

In some embodiments, the communication link(s) can be between a live, remote, adjunct healthcare provider and one or more medical product or service providers including, by way of non-limiting examples, pharmaceutical product providers, diagnostic service providers, and therapeutic service providers. In further embodiments, a live, remote, adjunct healthcare provider communicates with one or more medical product or service providers regarding products or services that are prescribed or recommended for a patient and/or the costs associated with such products or services.

In accordance with some embodiments, the communication link can be between a live, remote, adjunct healthcare provider and one or more consultants including, by way of non-limiting examples, medical consultants, legal consultants, insurance consultants, and financial consultants. In further embodiments, a live, remote, adjunct healthcare provider can communicate with one or more medical consultants regarding a patient's medical history, diagnosis, past, current, or contemplated therapies, or prognosis. In further embodiments, a live, remote, adjunct healthcare provider can communicate with one or more legal consultants regarding compliance with applicable laws, regulations, and rules. In further embodiments, a live, remote, adjunct healthcare provider can communicate with one or more insurance and financial consultants regarding a patient's eligibility, coverage, benefits, deductible, or payment status. In still further embodiments, multiple communication links are established with a plurality of providers and/or consultants to form a conference to remotely discuss the care of one or more patients.

According to some embodiments, the communications and/or data transmitted over the communication link(s) is recorded and stored. In an example, the audio, video, and health record data exchanged are recorded. In still further embodiments, recorded communications can be used by the security management component 1104 to assist in attempting to ensure sound medical policies and procedures, as well as compliance with applicable laws, regulations, and rules.

In some embodiments, the communication link(s) can be configured to conform to applicable data security standards. In some embodiments, the communication link(s) can be configured to conform to applicable patient privacy standards and/or requirements. In further embodiments, the applicable standards include, by way of non-limiting examples, the Health Insurance Portability and Accountability Act of 1996 and the Health Information Technology for Economic and Clinical Health Act of 2009. In some embodiments, live and/or recorded electronic communications can be encrypted. According to various implementations, cryptographic protocols such as Secure Sockets Layer (SSL) or Transport Layer Security (TLS), for example, can be applied to Internet-based communications such as web traffic, electronic mail, Internet faxing, instant message, and VoIP.

According to some embodiments, the disclosed aspects extend patient care effectiveness, professional answering, and triage services. Answering services can include receiving and sending communications regarding a patient on behalf of a primary healthcare provider facility, group, or individual (where the patient can be under the care of the primary provider). In accordance with some embodiments, extending patient care effectiveness includes, but is not limited to, the practices of healthcare delivery, diagnosis, consultations, treatment, transfer of medical information, and/or education. In still further embodiments, the various practices can be conducted during the non-working hours of a primary healthcare provider for a particular patient. In other embodiments, the various practices can be conducted when a primary healthcare provider for a particular patient is sick, busy, on vacation, at a seminar, attending to another patient, or otherwise unavailable. In still further embodiments, the various practices can be conducted using interactive audio, video, and/or data communications with a patient, onsite patient caregiver, healthcare provider, or consultant.

Further, the disclosed aspects can be adapted for use with other professions that might be overburdened, whose services would be beneficial remotely, professionals that are in need of answering client needs, triage, or client care services. Such processions include, but are not limited to, accountants, actuaries, advocates, architects, coaches, decorators (e.g., home decorators, office decorators), engineers, financial analysts, judges, law enforcement officers, lawyers, pilots, mechanics, pilots, pharmacists, professors, psychologists, scientists, veterinarians, and so on.

In accordance with various aspects, capture component 110 can be configured to pair with one or more models of electronic devices (e.g., medical devices, diagnostic devices, equipment testing devices, and so forth). In an example, capture component 110 can be pared with electronic and electronic Bluetooth stethoscopes. Such electronic Bluetooth stethoscopes can include, but are not limited to, Littman 3200 Electronic Stethoscope as well as stethoscopes from other manufactures including Cardionics Corp, Webster, Tex.; Point of Care, Corp, Toronto, Canada; 3M Corp [Littman], Minneapolis, Minn.; Welch Allyn Corp [Meditron], Skaneateles, N.Y.; and American Diagnostics Corp, Hauppauge, N.Y. In other embodiments, the electronic Bluetooth stethoscope can be replaced by a Bluetooth or other wirelessly connected high sensitivity microphone used to auscultate heart, lung, abdomen, and other body related sounds (as well as sounds related to other situations (e.g., vehicle sounds, animal sounds, earth movement, and so forth)).

At about the same time as the sounds (and/or videos) are captured, or at a different time, the sounds (and/or videos) can be transmitted to an intended recipient (e.g., healthcare provider). In some implementations, the auscultation (or other sounds) from the Bluetooth electronic stethoscope or high sensitivity wireless microphone can be encrypted prior to transmission to the computer or wireless device receiving and organizing the data. In some implementations, the video and audio physical examination data can be encrypted prior to upload to the intranet, internet, server, or directly to the review of the healthcare provider.

In accordance with various embodiments, capture component 110, separately or in conjunction with other system components and/or external devices, can be configured to electronically record the patient's history. The recording can include location, quality, severity, duration, timing, context, modifying factors, associated signs and symptoms as well as a complete (or partial) review of systems, past medical history, past surgical history, family history, social history, allergies, and active medication list. In some implementations, the electronic historical data can be integrated into the exam through a combination of text insertion and audio recordings, which can include the use of voice recognition.

In accordance with some aspects, an analysis component 1106 can be configured to review historical information 1108. The historical information 1108 can be stored internal to system 1100 (e.g., in memory 102) or external to system (e.g., in a database associated with the healthcare provider, in a database associated with a third-party, or other locations). The historical information 1108 can be reviewed by the analysis component 1106 based on keywords and/or phrases that are detected by the system 1100 (e.g., encountered during the remote physical examination). According to some implementations, the analysis component 1106 can be configured to dynamically output questions (e.g., history relevant questions) to the patient/onsite caregiver. According to other implementations, the analysis component 1106 can select certain keywords and/or phrases and provide the keywords/phrases to the healthcare provider, wherein the healthcare provider determines the questions to ask the patient/onsite caregiver. The history relevant questions can be adapted (automatically by the analysis component 1106 or another system component) based on prior responses during a current examination. According to some aspects, the history provided by the patient can be electronically recorded as audio and video files and uploaded for review by the healthcare provider.

According to some aspects, the patient might be admitted to a hospital or other healthcare facility based upon the results of the remote physical examination. According to some embodiments, the admitting privilege includes the right to admit patients to the facility for a specific diagnostic or therapeutic service. In other embodiments, the admitting privilege available to a physician is limited to a consultative service. In other embodiments, the admitting privilege is a right granted to a non-physician to treat patients independently with the appropriate state's oversight and review of the healthcare protocols used by a licensed, credentialed physician to empower the non-physician to execute healthcare.

According to some aspects, the analysis component 1106 and/or another system component employs artificial intelligence, which can facilitate automating one or more features in accordance with the disclosed aspects. For example, the disclosed aspects in connection with monitoring, analyzing, and reporting a virtual physical exam can employ various artificial intelligence-based schemes for carrying out various aspects thereof. For example, a process for receiving a patient identity, associating the patient identity with historical medical information, obtaining current medical information, storing the current medical information, and/or compiling the historic and current medical information can be facilitated with an example automatic classifier system and process. In another example, a process for creating reports from the historical and/or current medical information and providing the reports upon request and/or based on one or more triggering events can be facilitated with the example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed. In the case of remote virtual examination, for example, attributes can be medical symptoms and complaints and the classes can be the particular data related to the patient (e.g., age, weight, medical history, and so on).

A support vector machine is an example of a classifier that can be employed. The support vector machine can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, nave Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing a patients gait, observing lung and heart sounds, and so on). For example, support vector machines can be configured via a learning or training phase within a classifier constructor and feature selection module. Thus, the classifier(s) can be used to automatically learn and perform a number of functions, including but not limited to determining a potential medical condition that the patient might be experiencing, determining the patient had been previously misdiagnosed, detecting trends across two or more patients (e.g., a contagious disease), and so forth. The criteria can include, but is not limited to, similar medical conditions and/or complaints, health condition patterns across a subset of patients, and so on.

In view of the example systems shown and described herein, methods that may be implemented in accordance with the one or more of the disclosed aspects will be better understood with reference to the following flow charts. While, for purposes of simplicity of explanation, the methods are shown and described as a series of blocks, it is to be understood that the disclosed aspects are not limited by the number or order of blocks, as some blocks may occur in different orders and/or at substantially the same time as other blocks from what is depicted and described herein. Moreover, not all illustrated blocks may be required to implement the methods described hereinafter. It is noted that the functionality associated with the blocks may be implemented by software, hardware, a combination thereof or any other suitable means (e.g. device, system, process, component). Additionally, it is also noted that the methods disclosed hereinafter and throughout this specification are capable of being stored on an article of manufacture to facilitate transporting and transferring such methodologies to various devices. Those skilled in the art will understand that a method could alternatively be represented as a series of interrelated states or events, such as in a state diagram. The various methods disclosed herein can be performed by a system comprising at least one processor.

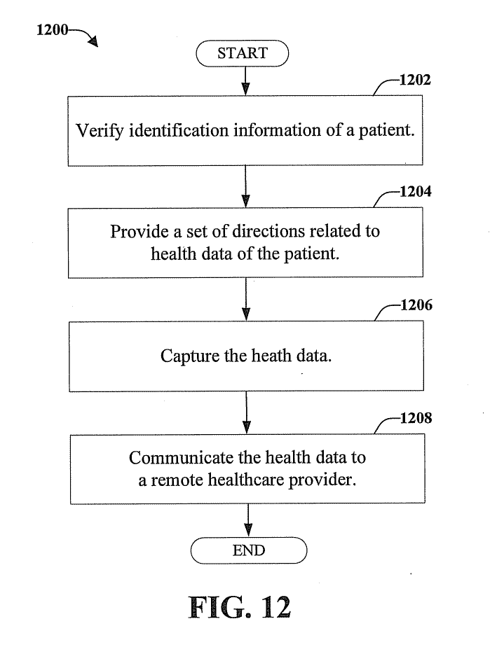

FIG. 12 illustrates an example, non-limiting method 1200 for virtual physical examinations, according to an aspect. The various aspects disclosed herein can extend patient care effectiveness of a primary healthcare provider, group, or individual (whether licensed or unlicensed). The various aspects can be configured to efficiently direct a technician, caregiver, patient and so on, to obtain key physical exam data including auditory and video data for storage or distribution via networking for the intent to be implemented into the medical record of the patient and/or for the immediate or delayed review by a healthcare provider. In an implementation, auscultation audio and physical exam audio and video maneuvers can be obtained and organized. The collection of audio and video can be facilitated through scientific validation to maximize reproducibility of findings. According to an implementation, the patient's history can be electronically recorded via text insertion and audio recordings, including the use of voice recognition. Optionally, history related questions can be output, wherein the questions can be dependent upon keywords that are automatically detected. One or more communication links between the patient(s)/patient caregiver(s) and the healthcare provider(s) can be established via secure telecommunication.

Method 1200 starts, at 1202, with verifying identification information indicative of an identity of a patient (e.g., using a verification manager component 106). The identification information indicative of a patient can include a patient name, medical record number, social security number, biometric data, and so on.

At 1204, a set of directions related to capturing a plurality of health data associated with the patient is provided to the patient and/or onsite caregiver (e.g., using an instruction manager component 108). The plurality of health data relates to a remote physical examination of the patient.

The plurality of health data is captured (e.g., using a capture component 110), at 1206, based on an indication that the plurality of health data is ready to be captured. For example, an instruction can be to move a stethoscope to a particular location on the patient's body. When the stethoscope is in place, the patient/onsite caregiver can indicate that the stethoscope is in place and associated audible sounds can be captured.

At 1208, the plurality of health data is communicated to a healthcare provider (e.g., using a communication component 112). For example, the plurality of health data can be encrypted and transmitted the healthcare provider (or a plurality of healthcare providers) over a secure link.

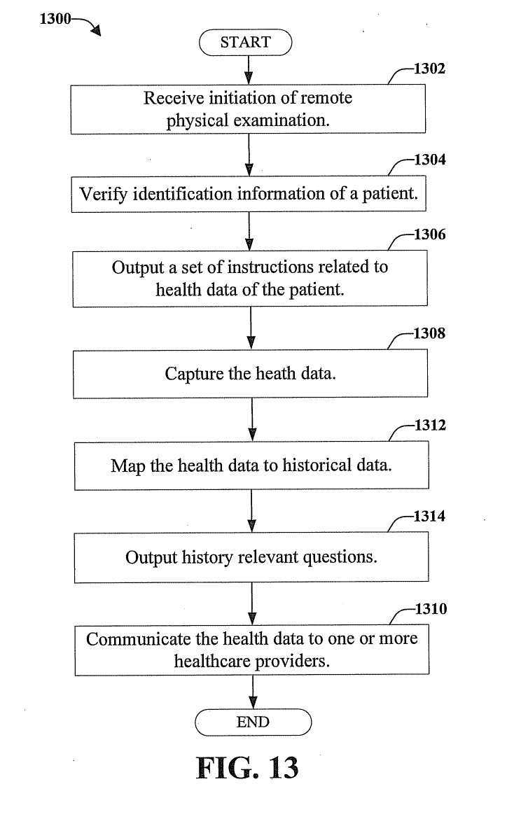

FIG. 13 illustrates another method 1300 for performing a remote physical examination, according to an aspect. At 1302, an initiation of a remote physical examination is received (e.g., using an initialization component 302 or an input component 304). The remote physical examination can be initiated by the patient and/or onsite caregiver. In an implementation, the patient/onsite caregiver downloads an application on their personal device in order to initiate the remote physical examination. At 1304, a patient identity is received and verified (e.g., using a verification manager component 106).

A set of instructions related to capturing various health data associated with the patient is output, at 1306 (e.g., using an instruction manager component 108). In an implementation, the set of instructions are output in a step-by-step manner. According to some implementations, the set of instructions guide the patient/onsite caregiver to one or more auscultation sites. In another implementation, outputting the set of instructions comprises providing the set of instructions as a series of video displays and/or verbal commands.

At 1308, the various health data is audibly captured and/or visually captured (e.g., using a capture component 110). For example, the instructions can guide the patient to one or more auscultation sites and a plurality of sounds associated with each of the one or more auscultation sites are captured. In another example, the instructions can guide the patient to take one or more pictures or a video of various portions of the patient's body (e.g., neck, leg, fingers, foot, and so on) and the picture(s) and/or video can be captured.

A communication link, which can be a secure communication link, is established and the captured health data is communicated to one or more healthcare providers, at 1310 (e.g., using a communication component 112). In accordance with an implementation, the heath data is compiled and transmitted at an end of the physical examination. According to other implementations, the health data is transmitted at about the same time the heath data is captured.

According to some implementations, at 1312, each of the plurality of health data is mapped to historical data associated with the patient (e.g., using a categorization manager component 202). The historical data can be retrieved from an electronic medical record or from another source (e.g., third party source). Based on the mapping, history relevant questions are output, at 1314 (e.g., using an analysis component 1106). Answers to the history relevant questions can be recorded as a portion of the remote physical examination. According to some aspects, the history relevant questions include obtaining additional and/or different visual and/or audible data than the data that has already been obtained during the remote physical examination.

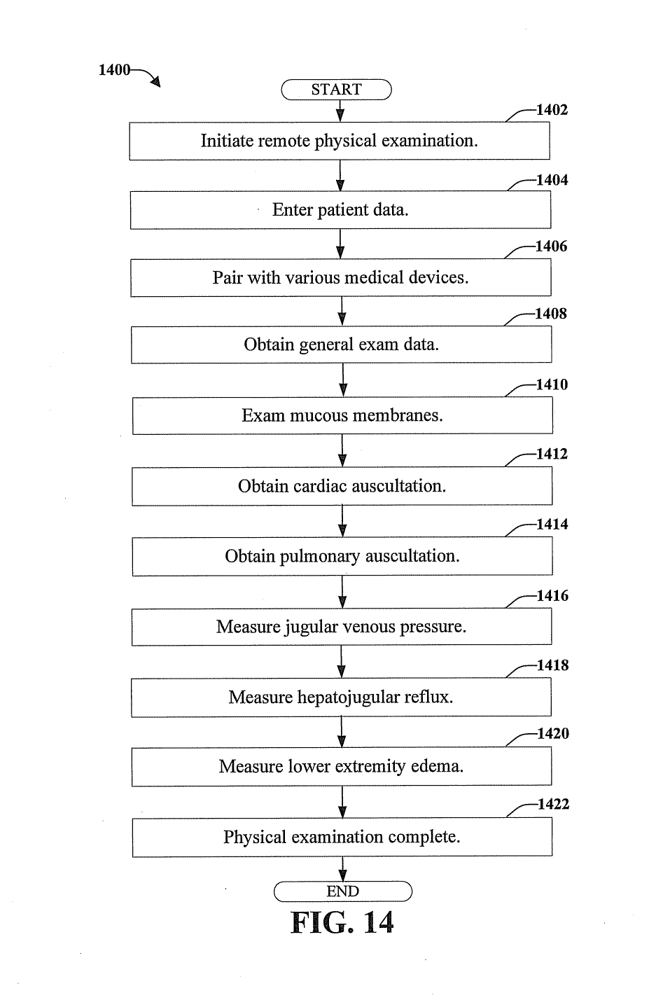

For purposes of describing the various aspects disclosed herein, FIG. 14 illustrates an example, non-limiting method 1400 of a remote physical examination, according to an aspect. The method is a representative of a software architecture for use by a healthcare provider, patient, onsite caregiver, and so on, according to an aspect.

At 1402, a remote physical examination is initiated (e.g., using an initialization component 302). For example, a device located at the patient site can indicate that the physical examination is to begin. In an example, a display of the device can indicate “Welcome to Virtual Physical”. However, other manners of initiating the examination can be utilized with the disclosed aspects.

Patient data is entered, at 1404 (e.g., using an input component 304). For example, the patient data can include, but is not limited to: patient name, medical record number, a scanned identification badge, and so on. Patient data can also include a selection of the patient's posture (e.g., supine, semi-supine (enter degrees), sitting upright (90 degrees), and so on).

At 1406, pairing with one or more medical devices is performed, as discussed herein. General exam data is obtained, at 1408 (e.g., using a capture component 110). For example, an instruction can be output that indicates, “Please pan camera from head to foot over the course of ten seconds”. In this case a camera can activate (e.g., turns on) and records for ten seconds.

Examination of mucous membranes can be obtained at 1410. In this case, a light can turn on and the camera can turn on and record for a predetermined amount of time (e.g., ten seconds).

At 1412, cardiac auscultation is obtained. According to an implementation, the patient/onsite caregiver can be instructed to indicate when the medical device is positioned corrected. After the correct position is obtained, the patient can indicate that recording can begin and the medical device can record the information at the site for a set amount of time. The patient can be instructed to obtain data at other sites in a similar manner. The following is an example, non-limiting embodiment of a step-by-step interaction between the remote physical examination software, the patient, and a device (e.g., associated with capture component 110).
Instruction to patient: “Press M button when at Aortic site”.
Examination software displays 3D model with landmark at second right intercostal space.
Device beeps after 15 seconds of continuous recording.
Instruction to patient: “Press M button when at Pulmonary site”.
Examination software displays 3D model with landmark at third left intercostal space.
Device beeps after 15 seconds of continuous recording.
Instruction to patient: “Press M button when at Tricuspid site”.
Examination software displays 3D model with landmark at fourth intercostal space of lower left sternal border.
Device beeps after 15 seconds of continuous recording.
Instruction to patient: “Press M button when at Mitral site”.
Examination software displays 3D model with landmark at fifth left intercostal space, 1 cm medial to midclavicular line.
Device beeps after 15 seconds of continuous recording.
Instruction to patient: “Press M button when at Right carotid”.
Examination software displays 3D model of Right carotid.
Device beeps after 15 seconds of continuous recording.
Instruction to patient: “Press M button when at Left carotid”.
Examination software displays 3D model of Left carotid.
Device beeps after 15 seconds of continuous recording.
Instruction to patient: “Press M button when at Right femoral”.
Examination software displays 3D model of Right femoral.
Device beeps after 15 seconds of continuous recording.
Instruction to patient: “Press M button when at Left femoral”.
Examination software displays 3D model of Left femoral.
Device beeps after 15 seconds of continuous recording.
Instruction to patient: “Press M button when at mid-abdomen”.
Examination software displays 3D model of Abdominal aorta.
Device beeps after 15 seconds of continuous recording.
Instruction to patient: “Press M button when at Left carotid”.
Examination software displays 3D model of Left carotid.
Device beeps after 15 seconds of continuous recording.

With continuing reference to FIG. 14, at 1414, pulmonary auscultation can be obtained. The following is an example, non-limiting embodiment of a step-by-step interaction between the remote physical examination software, the patient, and the device.
Instruction to patient: Choose “Anterior or Posterior”.
Instruction to patient: “Press M button when at Left Upper site and ask patient to take a deep breath through mouth”.
Examination software displays 3D model with landmark at Right Upper pulmonary site.
Device beeps after 10 seconds of continuous recording.
Instruction to patient: “Press M button when at Right Upper site and ask patient to take a deep breath through mouth”.
Examination software displays 3D model with landmark at Left Upper pulmonary site.
Device beeps after 10 seconds of continuous recording.
Instruction to patient: “Press M button when at Left Middle site and ask patient to take a deep breath through mouth”.
Examination software displays 3D model with landmark at Left Middle pulmonary site.
Device beeps after 10 seconds of continuous recording.
Instruction to patient: “Press M button when at Right Middle site and ask patient to take a deep breath through mouth”.
Examination software displays 3D model with landmark at Right Middle pulmonary site.
Device beeps after 10 seconds of continuous recording.
Instruction to patient: “Press M button when at Left Lower site and ask patient to take a deep breath through mouth”.
Examination software displays 3D model with landmark at Left Lower pulmonary site.
Device beeps after 10 seconds of continuous recording.
Instruction to patient: “Press M button when at Right Lower site and ask patient to take a deep breath through mouth”.
Examination software displays 3D model with landmark at Right Lower pulmonary site.
Device beeps after 10 seconds of continuous recording.

At 1416, jugular venous pressure can be measured. The following is an example, non-limiting embodiment of a step-by-step interaction between the remote physical examination software, the patient, and the device.
Instruction to patient: Enter degrees patient is reclining (preferably 45°).
Instruction to patient: “Place vertical device (e.g. phone) with base at level of sternal angle aligned with the Right mid-clavicular line and press Obtain”.
Examination software displays 3D model with model of device with base at level of Right sternal angle aligned with the midclavicular line.
Information to patient: Sternal angle is approximately 5 cm above the right atrium.
Information to patient: 5 cm plus 11 cm from base to camera places camera at 16 cm.
Device: Light and camera turns on and records for 10 seconds; light should be tangential to illuminate highlights and shadows.
Instruction to patient: “Place horizontal device with camera lens over lateral Right shoulder and press Obtain”.
Examination software displays 3D model with model of device with camera lens over lateral Right shoulder.
Instruction to patient: “Place vertical device with base at level of sternal angle aligned with the Left mid-clavicular line and press Obtain”.
Examination software displays 3D model with model of device with base at level of Left sternal angle aligned with the midclavicular line.
Information to patient: Sternal angle is approximately 5 cm above the right atrium.
Information to patient: 5 cm plus 11 cm from base to camera places camera at 16 cm.
Device: Light and camera turns on and records for 10 seconds; light should be tangential to illuminate highlights and shadows.
Instruction to patient: “Place horizontal device with camera lens over lateral Left shoulder and press Obtain”.
Examination software displays 3D model with model of device with camera lens over lateral Left shoulder

At 1418, hepatojugular reflux can be measured. The following is an example, non-limiting embodiment of a step-by-step interaction between the remote physical examination software, the patient, and the device.
Instruction to patient: “Place vertical device with base at level of sternal angle aligned with the Right mid-clavicular line with one hand while applying gentle pressure (30-40 mm Hg) over the right upper quadrant for 10 seconds and then press Obtain”.
Examination software displays 3D model with model of device with base at level of Right sternal angle aligned with the midclavicular line with one hand applying right upper quadrant pressure.
Device: Light and camera turns on and records for 10 seconds; light should be tangential to illuminate highlights and shadows.
Instruction to patient: “Place vertical device with base at level of sternal angle aligned with the Left mid-clavicular line with one hand while applying gentle pressure (30-40 mm Hg) over the right upper quadrant for 10 seconds and then press Obtain”.
Examination software displays 3D model with model of device with base at level of Left sternal angle aligned with the midclavicular line with one hand applying right upper quadrant pressure.
Device: Light and camera turns on and records for 10 seconds; light should be tangential to illuminate highlights and shadows.

At 1420, lower extremity edema can be measured. The following is an example, non-limiting embodiment of a step-by-step interaction between the remote physical examination software, the patient, and the device.
Instruction to patient: “Place horizontal device at Right mid-calf, press “Obtain”, and apply 20-30 mm Hg with index finger at lower calf at 7 cm proximal to the midpoint of the medial malleolus”.
Device: Light and camera turns on and records for 10 seconds.
Instruction to patient: “Place horizontal device at Right mid-calf, press “Obtain”, and apply 20-30 mm Hg with index finger behind the medial malleolus”.
Device: Light and camera turns on and records for 10 seconds.
Instruction to patient: “Place horizontal device at Right mid-calf, press “Obtain”, and apply 20-30 mm Hg with index finger on the dorsum of the foot”.
Device: Light and camera turns on and records for 10 seconds.
Instruction to patient: “Place horizontal device at Left mid-calf, press “Obtain”, and apply 20-30 mm Hg with index finger at lower calf at 7 cm proximal to the midpoint of the medial malleolus”.
Device: Light and camera turns on and records for 10 seconds.
Instruction to patient: “Place horizontal device at Left mid-calf, press “Obtain”, and apply 20-30 mm Hg with index finger behind the medial malleolus”.
Device: Light and camera turns on and records for 10 seconds.
Instruction to patient: “Place horizontal device at Left mid-calf, press “Obtain”, and apply 20-30 mm Hg with index finger on the dorsum of the foot”.
Device: Light and camera turns on and records for 10 seconds.

At 1422, the physical exam is complete. For example, the patient/onsite caregiver can be instructed to, “Please press Upload to complete exam and send data for interpretation”.

As discussed herein, multiple industries have emerged around the needs of overworked providers and chronically short-staffed healthcare provider facilities and groups. Technology increasingly offers opportunities to meaningfully address the barriers to patient care effectiveness and to reduce the cost of healthcare. For example, improved communications systems allow healthcare providers to connect with patients across distances. Further, electronic health records enhance the portability and accessibility of patients' medical histories. Despite these opportunities, telemedicine systems have failed to address existing medical requirements including providing remote healthcare providers access to complete histories and physical examinations to be efficiently reviewed and acted upon by clinicians.

To overcome the above as well as other challenges, the disclosed aspects can provide a computer-implemented remote healthcare system for extending patient care effectiveness of a licensed (or unlicensed) primary healthcare provider facility, group, or individual and providing professional triage services. The various aspects can include a digital processing device connected to a computer network. The processing device can include a computer readable storage device and an operating system configured to perform executable instructions.

The digital processing device can include one or more hardware central processing units (CPU) that carry out the device's functions. The digital processing device can further comprise an operating system configured to perform executable instructions. In some embodiments, the digital processing device further comprises a memory device, a display, an input device, and optionally a sound output device. In some embodiments, the digital processing device is connected to the Internet such that the digital processing device can access the World Wide Web. In other embodiments, the digital processing device can be connected to an intranet. In other embodiments, the digital processing device can be connected to a data storage device. In some embodiments, the digital processing device is a non-portable device, such as a server or a desktop computer. In other embodiments, the digital processing device is a portable device, such as a laptop or tablet computer. In other embodiments, the digital processing device is a mobile device, such as a smartphone or digital music player.

The digital processing device can include an operating system configured to perform executable instructions. The operating system can be, for example, software, including programs and data, which can manage the device's hardware and provides services for execution of applications. In some embodiments, the operating system is provided by cloud computing.

In some embodiments, the digital processing device includes a memory device. The memory can be one or more physical apparatus used to store data or programs on a temporary or permanent basis. In some embodiments, the memory is volatile and requires power to maintain stored information. In some embodiments, the memory is non-volatile and retains stored information when the digital processing device is not powered.

In some embodiments, the digital processing device includes a visual display. In some embodiments, the display is a cathode ray tube (CRT), a liquid crystal display (LCD), a thin film transistor liquid crystal display (TFT-LCD), a plasma display, a video projector, or a combination thereof.

In some embodiments, the digital processing device includes an input device. In some embodiments, the input device is a keyboard or a keypad. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices.

In some embodiments, the digital processing device optionally includes a sound output device. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices.

In accordance with the disclosed aspects, suitable digital processing devices include, by way of non-limiting examples, server computers, desktop computers, laptop computers, notebook computers, tablet computers, netbook computers, smartbook computers, subnotebook computers, ultra-mobile PCs, handheld computers, personal digital assistants, Internet appliances, smartphones, music players, and portable video game systems. Those of skill in the art will recognize that many mobile smartphones are suitable for use in the system described herein. Suitable tablet computers include those with booklet, slate, and convertible configurations, known to those of skill in the art.

According to some implementations, the digital processing device can be optionally connected to a computer network. A computer network is a collection of computers and/or devices interconnected by communications channels that facilitate communications among users and allow users to share resources. In view of the disclosed aspects, the computer network can be created by techniques known to those of skill in the art using hardware, firmware, and/or software. In some embodiments, the computer network is a private network such as an intranet. In other embodiments, the computer network is the Internet. In further embodiments, the Internet provides access to the World Wide Web and the computer program and/or mobile application is provided to the digital processing device via the Web. In still further embodiments, the Internet provides access to the World Wide Web and the computer program and/or mobile application is provided to the digital processing device via cloud computing. In other embodiments, the computer network comprises data storage devices including, by way of non-limiting examples, CD-ROMs, DVDs, flash memory devices, solid state memory, magnetic disk drives, magnetic tape drives, optical disk drives, cloud computing systems and services, and the like. In further embodiments, the computer program and/or mobile application is provided to the digital processing device via a data storage device.

In some embodiments, the aspects disclosed herein include one or more computer readable media encoded with a program including instructions executable by the operating system of an optionally networked digital processing device. In further embodiments, a computer readable medium is a tangible component of a digital processing device. In still further embodiments, a computer readable medium is optionally removable from a digital processing device. In some embodiments, a computer readable medium includes, by way of non-limiting examples, CD-ROMs, DVDs, flash memory devices, solid state memory, magnetic disk drives, magnetic tape drives, optical disk drives, cloud computing systems and services, and the like.

The one or more aspects disclosed herein can include at least one computer program. The computer program can include a sequence of instructions, executable in the digital processing device's CPU, written to perform a specified task. Those of skill in the art will recognize that the computer program may be written in various versions of various languages. In some embodiments, the computer program comprises one sequence of instructions or a plurality of sequences of instructions. In some embodiments, the computer program is delivered from one location or from a plurality of locations. In various embodiments, the computer program includes one or more software modules. In various embodiments, the computer program includes, in part or in whole, one or more web applications, one or more mobile applications, one or more standalone applications, one or more web browser plug-ins, extensions, add-ins, or add-ons, or combinations thereof.

In some embodiments, the computer program includes a web application written in one or more markup languages, style languages, client-side scripting languages, server-side coding languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a style language such as Cascading Style Sheets (CSS).

In some embodiments, the computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the aspects disclosed herein, the mobile application can be created by various techniques using hardware, languages, and development environments. Those of skill in the art will recognize that mobile applications can be written in several languages. Those of skill in the art will also recognize that mobile application development environments are available from several sources. Further, those of skill in the art will recognize that several commercial forums are available for distribution of mobile applications.

In some embodiments, the computer program includes a standalone application, which is a program that is run as an independent computer process, not an add-on to an existing process (e.g. not a plug-in). Those of skill in the art will recognize that standalone applications are often compiled. A compiler is a computer program(s) that transforms source code written in a programming language into binary object code such as assembly language or machine code. Compilation is often performed, at least in part, to create an executable program. In some embodiments, the computer program includes one or more executable complied applications.

The various aspects disclosed herein include, in various embodiments, software, server, and database modules. The software modules can be created by techniques known to those of skill in the art using machines, software, and languages. The software modules disclosed herein are implemented in a multitude of ways. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In some embodiments, software modules are hosted on one or more machines in one location. In other embodiments, software modules are hosted on one or more machines in more than one location.

Also included herein is a computer program, which can be provided to the digital processing device. The computer program can include executable instructions operable to create a remote virtual history and physical examination and can include various software modules. Such software modules can include a first software module for verifying and identifying a patient by name, social security number, medical record number, birthdate, and so forth, and/or by scanning a bar code or Quick Response code. The software modules can also include a second software module that efficiently directs a technician to electronically record a complete physical examination in a step wise fashion. The physical examination can be comprehensive or focused, as specified by a healthcare professional, for example. The second software module can be configured for pairing with numerous models of electronic Bluetooth stethoscopes, for example. The second software module can also be configured to guide a technician to appropriate auscultation sites and can assign auditory files to these anatomic locations. Further, the second software module can be configured to guide the technician to obtain video of physical exam findings and can direct the technician to perform physical exam maneuvers to be recorded by the audio and video recording device. Upon completion of recording electronic physical exam, the data can encrypted and organized for upload for storage on server or for immediate broadcast to healthcare provider.

According to some implementations, the software modules can include a third software module that can electronically record the patient's history including location, quality, severity, duration, timing, context, modifying factors, associated signs and symptoms as well as a complete review of symptoms, past medical history, past surgical history, family history, social history, allergies, and active medication list. The electronic historical data can be integrated into the exam via a combination of text insertion and audio recordings including the use of voice recognition. Further, the third software module can comprise one or more algorithms that provide directed history related questions dependent upon prior keywords detected by the software.

Also included can be a fourth software module configured to securely download complete history and physical examination data of verified patients (e.g., authenticated patients) for review by one or more healthcare providers. Additionally, a fifth software module can be configured to create and maintain a communication link between the patient/onsite caregiver and the healthcare provider via a secure telecommunication, which can include phone or videoconference.

In some embodiments, another software module can be configured to electronically record all communications between the remote adjunct healthcare provider and the patient/onsite caregiver(s).

According to an embodiment, the remote adjunct care can be initiated by the patient(s), the onsite patient caregiver(s), or by the primary healthcare provider facility, group, or individual. In accordance with some embodiments, the remote adjunct healthcare provider can be a physician. Alternatively, the remote adjunct healthcare provider can be a non-physician. In an embodiment, the patient can be admitted to the healthcare facility. However, in an alternative embodiment, the patient is not admitted to the healthcare facility.

According to various embodiments, the patient authorizes the provider's access to their electronic health records. In an implementation, a software module can be configured to provide the remote adjunct healthcare provider access to one or more electronic health records and further verifies the remote healthcare provider's identity.

In an embodiment, the electronic health records are generated by an electronic device that is present with (e.g., in the same location as) the patient. According to an embodiment, the electronic device is a biometric sensor, portable imaging device, or portable auscultation device.

In accordance with an embodiment, the communication links enable communication via one or more of: telephone, push-to-talk, audio conference, video conference, SMS, MMS, instant message, Internet bulletin board, blog, microblog, fax, Internet fax, electronic mail, and VoIP, for example.

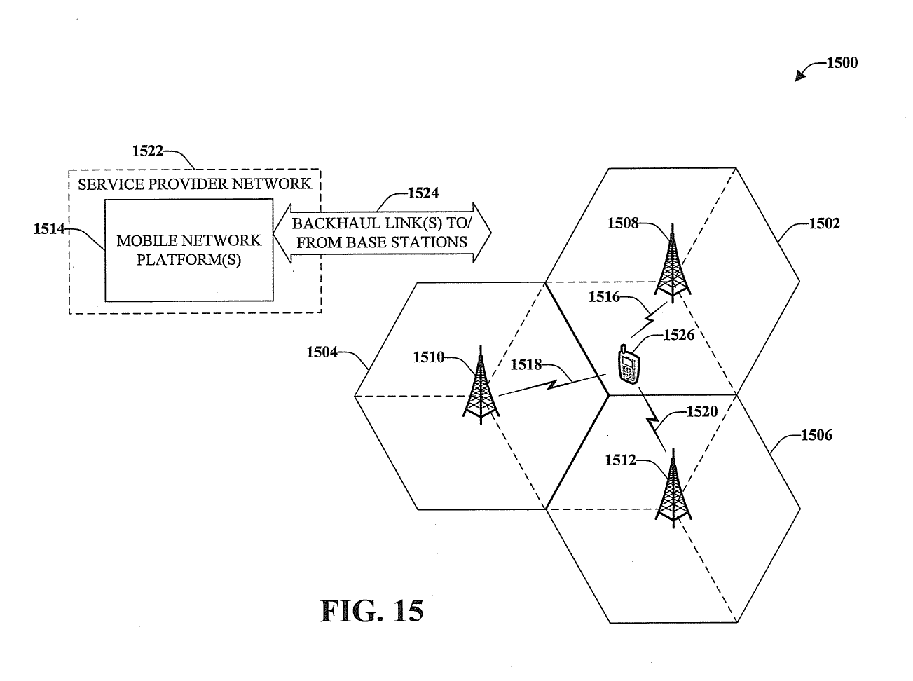

By way of further description with respect to one or more non-limiting ways to facilitate remote, virtual physical exam acquisition and distribution, FIG. 15 is a schematic example wireless environment 1500 that can operate in accordance with aspects described herein. In particular, example wireless environment 1500 illustrates a set of wireless network macro cells. Three coverage macro cells 1502, 1504, and 1506 include the illustrative wireless environment; however, it is noted that wireless cellular network deployments can encompass any number of macro cells. Coverage macro cells 1502, 1504, and 1506 are illustrated as hexagons; however, coverage cells can adopt other geometries generally dictated by a deployment configuration or floor plan, geographic areas to be covered, and so on. Each macro cell 1502, 1504, and 1506 is sectorized in a 2π/3 configuration in which each macro cell includes three sectors, demarcated with dashed lines in FIG. 15. It is noted that other sectorizations are possible, and aspects or features of the disclosed subject matter can be exploited regardless of type of sectorization. Macro cells 1502, 1504, and 1506 are served respectively through base stations or eNodeBs 1508, 1510, and 1512. Any two eNodeBs can be considered an eNodeB site pair. It is noted that radio component(s) are functionally coupled through links such as cables (e.g., RF and microwave coaxial lines), ports, switches, connectors, and the like, to a set of one or more antennas that transmit and receive wireless signals (not illustrated). It is noted that a radio network controller (not shown), which can be a part of mobile network platform(s) 1514, and set of base stations (e.g., eNode B 1508, 1510, and 1512) that serve a set of macro cells; electronic circuitry or components associated with the base stations in the set of base stations; a set of respective wireless links (e.g., links 1516, 1518, and 1520) operated in accordance to a radio technology through the base stations, form a macro radio access network. It is further noted that, based on network features, the radio controller can be distributed among the set of base stations or associated radio equipment. In an aspect, for universal mobile telecommunication system-based networks, wireless links 1516, 1518, and 1520 embody a Uu interface (universal mobile telecommunication system Air Interface).

Mobile network platform(s) 1514 facilitates circuit switched-based (e.g., voice and data) and packet-switched (e.g., Internet protocol, frame relay, or asynchronous transfer mode) traffic and signaling generation, as well as delivery and reception for networked telecommunication, in accordance with various radio technologies for disparate markets. Telecommunication is based at least in part on standardized protocols for communication determined by a radio technology utilized for communication. In addition, telecommunication can exploit various frequency bands, or carriers, which include any electromagnetic frequency bands licensed by the service provider network 1522 (e.g., personal communication services, advanced wireless services, general wireless communications service, and so forth), and any unlicensed frequency bands currently available for telecommunication (e.g., the 2.4 GHz industrial, medical and scientific band or one or more of the 5 GHz set of bands). In addition, mobile network platform(s) 1514 can control and manage base stations 1508, 1510, and 1512 and radio component(s) associated thereof, in disparate macro cells 1502, 1504, and 1506 by way of, for example, a wireless network management component (e.g., radio network controller(s), cellular gateway node(s), etc.). Moreover, wireless network platform(s) can integrate disparate networks (e.g., Wi-Fi network(s), femto cell network(s), broadband network(s), service network(s), enterprise network(s), and so on). In cellular wireless technologies (e.g., third generation partnership project universal mobile telecommunication system, global system for mobile communication, mobile network platform 1514 can be embodied in the service provider network 1522.

In addition, wireless backhaul link(s) 1524 can include wired link components such as T1/E1 phone line; T3/DS3 line, a digital subscriber line either synchronous or asynchronous; an asymmetric digital subscriber line; an optical fiber backbone; a coaxial cable, etc.; and wireless link components such as line-of-sight or non-line-of-sight links which can include terrestrial air-interfaces or deep space links (e.g., satellite communication links for navigation). In an aspect, for universal mobile telecommunication system-based networks, wireless backhaul link(s) 1524 embodies IuB interface.

It is noted that while exemplary wireless environment 1500 is illustrated for macro cells and macro base stations, aspects, features and advantages of the disclosed subject matter can be implemented in micro cells, pico cells, femto cells, or the like, wherein base stations are embodied in home-based equipment related to access to a network.

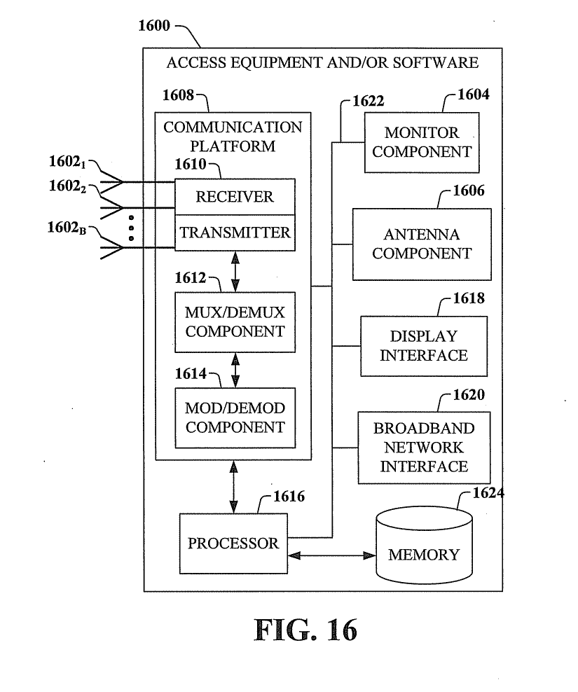

To provide further context for various aspects of the disclosed subject matter, FIG. 16 illustrates a block diagram of an embodiment of access equipment and/or software 1600 related to access of a network (e.g., base station, wireless access point, femtocell access point, and so forth) that can enable and/or exploit features or aspects of the disclosed aspects.

Access equipment and/or software 1600 related to access of a network can receive and transmit signal(s) from and to wireless devices, wireless ports, wireless routers, etc. through segments 1602₁-1602_{B} (B is a positive integer). Segments 1602₁-1602_{B} can be internal and/or external to access equipment and/or software 1600 related to access of a network, and can be controlled by a monitor component 1604 and an antenna component 1606. Monitor component 1604 and antenna component 1606 can couple to communication platform 1608, which can include electronic components and associated circuitry that provide for processing and manipulation of received signal(s) and other signal(s) to be transmitted.

In an aspect, communication platform 1608 includes a receiver/transmitter 1610 that can convert analog signals to digital signals upon reception of the analog signals, and can convert digital signals to analog signals upon transmission. In addition, receiver/transmitter 1610 can divide a single data stream into multiple, parallel data streams, or perform the reciprocal operation. Coupled to receiver/transmitter 1610 can be a multiplexer/demultiplexer 1612 that can facilitate manipulation of signals in time and frequency space. Multiplexer/demultiplexer 1612 can multiplex information (data/traffic and control/signaling) according to various multiplexing schemes such as time division multiplexing, frequency division multiplexing, orthogonal frequency division multiplexing, code division multiplexing, space division multiplexing. In addition, multiplexer/demultiplexer component 1612 can scramble and spread information (e.g., codes, according to substantially any code known in the art, such as Hadamard-Walsh codes, Baker codes, Kasami codes, polyphase codes, and so forth).

A modulator/demodulator 1614 is also a part of communication platform 1608, and can modulate information according to multiple modulation techniques, such as frequency modulation, amplitude modulation (e.g., M-ary quadrature amplitude modulation, with M a positive integer); phase-shift keying; and so forth).

Access equipment and/or software 1600 related to access of a network also includes a processor 1616 configured to confer, at least in part, functionality to substantially any electronic component in access equipment and/or software 1600. In particular, processor 1616 can facilitate configuration of access equipment and/or software 1600 through, for example, monitor component 1604, antenna component 1606, and one or more components therein. Additionally, access equipment and/or software 1600 can include display interface 1618, which can display functions that control functionality of access equipment and/or software 1600, or reveal operation conditions thereof. In addition, display interface 1618 can include a screen to convey information to an end user. In an aspect, display interface 1618 can be a liquid crystal display), a plasma panel, a monolithic thin-film based electrochromic display, and so on. Moreover, display interface 1618 can include a component (e.g., speaker) that facilitates communication of aural indicia, which can also be employed in connection with messages that convey operational instructions to an end user. Display interface 1618 can also facilitate data entry (e.g., through a linked keypad or through touch gestures), which can cause access equipment and/or software 1600 to receive external commands (e.g., restart operation).

Broadband network interface 1620 facilitates connection of access equipment and/or software 1600 to a service provider network (not shown) that can include one or more cellular technologies (e.g., third generation partnership project universal mobile telecommunication system, global system for mobile communication, and so on.) through backhaul link(s) (not shown), which enable incoming and outgoing data flow. Broadband network interface 1620 can be internal or external to access equipment and/or software 1600, and can utilize display interface 1618 for end-user interaction and status information delivery.

Processor 1616 can be functionally connected to communication platform 1608 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 1616 can be functionally connected, through data, system, or an address bus 1622, to display interface 1618 and broadband network interface 1620, to confer, at least in part, functionality to each of such components.

In access equipment and/or software 1600, memory 1624 can retain location and/or coverage area (e.g., macro sector, identifier(s)), access list(s) that authorize access to wireless coverage through access equipment and/or software 1600, sector intelligence that can include ranking of coverage areas in the wireless environment of access equipment and/or software 1600, radio link quality and strength associated therewith, or the like. Memory 1624 also can store data structures, code instructions and program modules, system or device information, code sequences for scrambling, spreading and pilot transmission, access point configuration, and so on. Processor 1616 can be coupled (e.g., through a memory bus), to memory 1624 in order to store and retrieve information used to operate and/or confer functionality to the components, platform, and interface that reside within access equipment and/or software 1600.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in memory 1624, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate, synchronous dynamic random access memory, enhanced synchronous dynamic random access memory, Synchlink dynamic random access memory, and direct Rambus random access memory. Additionally, the disclosed memory components of systems or methods herein are intended to include, without being limited to including, these and any other suitable types of memory.

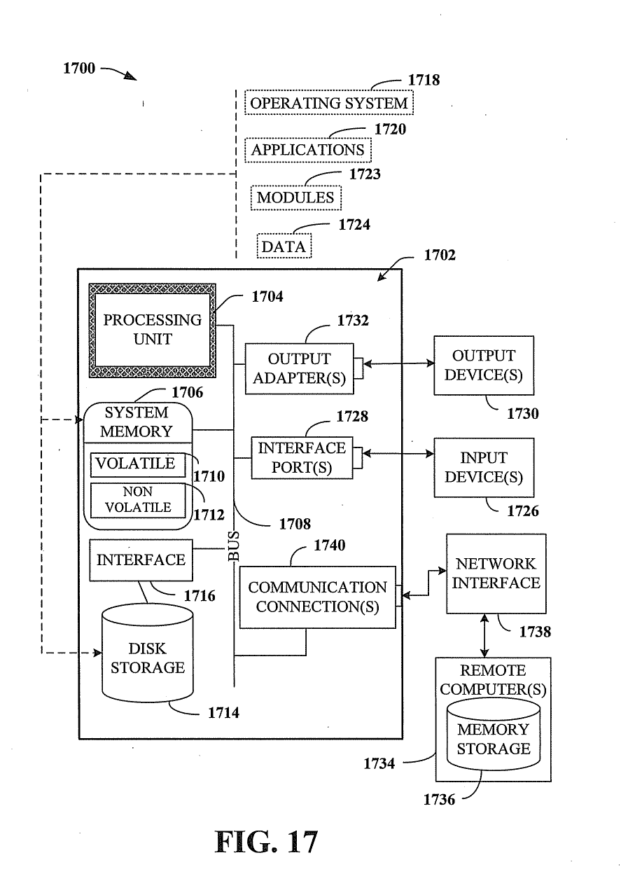

In order to provide a context for the various aspects of the disclosed subject matter, FIG. 17, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the various aspects also can be implemented in combination with other program modules. Generally, program modules include routines, programs, components, data structures, etc. that perform particular tasks and/or implement particular abstract data types. For example, in memory (such as at least one memory 102) there can be software, which can instruct a processor (such as at least one processor 104) to perform various actions. The processor can be configured to execute the instructions in order to implement the analysis of monitoring an uplink power level, detecting the uplink power level is at or above a threshold level, and/or disable transmission of at least one message as a result of the monitored uplink power level.

Moreover, those skilled in the art will understand that the various aspects can be practiced with other computer system configurations, including single-processor or multiprocessor computer systems, mini-computing devices, mainframe computers, as well as personal computers, base stations hand-held computing devices or user equipment, such as a tablet, phone, watch, and so forth, processor-based computers/systems, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 17, a block diagram of a computing system 1700 operable to execute the disclosed systems and methods is illustrated, in accordance with an embodiment. Computer 1702 includes a processing unit 1704, a system memory 1706, and a system bus 1708. System bus 1708 couples system components including, but not limited to, system memory 1706 to processing unit 1704. Processing unit 1704 can be any of various available processors. Dual microprocessors and other multiprocessor architectures also can be employed as processing unit 1704.

System bus 1708 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (institute of electrical and electronics engineers 1194), and small computer systems interface.

System memory 1706 includes volatile memory 1710 and nonvolatile memory 1712. A basic input/output system, containing routines to transfer information between elements within computer 1702, such as during start-up, can be stored in nonvolatile memory 1712. By way of illustration, and not limitation, nonvolatile memory 1712 can include read only memory, programmable read only memory, electrically programmable read only memory, electrically erasable programmable read only memory, or flash memory. Volatile memory 1710 can include random access memory, which acts as external cache memory. By way of illustration and not limitation, random access memory is available in many forms such as dynamic random access memory, synchronous random access memory, synchronous dynamic random access memory, double data rate synchronous dynamic random access memory, enhanced synchronous dynamic random access memory, Synchlink dynamic random access memory, and direct Rambus random access memory, direct Rambus dynamic random access memory, and Rambus dynamic random access memory.

Computer 1702 also includes removable/non-removable, volatile/non-volatile computer storage media. In an implementation, provided is a non-transitory or tangible computer-readable medium storing computer-executable instructions that, in response to execution, cause a system comprising a processor to perform operations. The operations can include outputting a set of directions related to capturing a plurality of health data associated with a patient, wherein the plurality of health data relates to a remote physical examination of the patient. The operations can also include receiving an indication that at least one health data of the plurality of health data is available and recording the at least one health data in a visual format, an audible format, or both a visual format and an audible format. Further, the operations can include establishing a communication link between the patient and a healthcare provider and transmitting the at least one health data over the communication link. The patient can be located remotely from the healthcare provider.

According to an implementation, the operations can also include providing the set of directions to guide the patient to one or more auscultation sites. Further, the operations can include obtaining a plurality of sounds associated with each of the one or more auscultation sites.

FIG. 17 illustrates, for example, disk storage 1714. Disk storage 1714 includes, but is not limited to, devices such as a magnetic disk drive, floppy disk drive, tape drive, Jaz drive, Zip drive, superdisk drive, flash memory card, or memory stick. In addition, disk storage 1714 can include storage media separately or in combination with other storage media including, but not limited to, an optical disk drive such as a compact disk read only memory device, compact disk recordable drive, compact disk rewritable drive or a digital versatile disk read only memory drive. To facilitate connection of the disk storage 1714 to system bus 1708, a removable or non-removable interface is typically used, such as interface component 1716.

It is to be noted that FIG. 17 describes software that acts as an intermediary between users and computer resources described in suitable operating environment. Such software includes an operating system 1718. Operating system 1718, which can be stored on disk storage 1714, acts to control and allocate resources of computer system 1702. System applications 1720 can take advantage of the management of resources by operating system 1718 through program modules 1722 and program data 1724 stored either in system memory 1706 or on disk storage 1714. It is to be understood that the disclosed subject matter can be implemented with various operating systems or combinations of operating systems.

A user can enter commands or information, for example through interface component 1716, into computer system 1702 through input device(s) 1726. Input devices 1726 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1704 through system bus 1708 through interface port(s) 1728. Interface port(s) 1728 include, for example, a serial port, a parallel port, a game port, and a universal serial bus. Output device(s) 1730 use some of the same type of ports as input device(s) 1726.

Thus, for example, a universal serial bus port can be used to provide input to computer 1702 and to output information from computer 1702 to an output device 1730. Output adapter 1732 is provided to illustrate that there are some output devices 1730, such as monitors, speakers, and printers, among other output devices 1730, which use special adapters. Output adapters 1732 include, by way of illustration and not limitation, video and sound cards that provide means of connection between output device 1730 and system bus 1708. It is also noted that other devices and/or systems of devices provide both input and output capabilities such as remote computer(s) 1734.

Computer 1702 can operate in a networked environment using logical connections to one or more remote computers, such as remote computer(s) 1734. Remote computer(s) 1734 can be a personal computer, a server, a router, a network computer, a workstation, a microprocessor based appliance, a peer device, or other common network node and the like, and typically includes many or all of the elements described relative to computer 1702.

For purposes of brevity, only one memory storage device 1736 is illustrated with remote computer(s) 1734. Remote computer(s) 1734 is logically connected to computer 1702 through a network interface 1738 and then physically connected through communication connection 1740. Network interface 1738 encompasses wire and/or wireless communication networks such as local area networks and wide area networks. Local area network technologies include fiber distributed data interface, copper distributed data interface, Ethernet, token ring and the like. Wide area network technologies include, but are not limited to, point-to-point links, circuit switching networks like integrated services digital networks and variations thereon, packet switching networks, and digital subscriber lines.

Communication connection(s) 1740 refer(s) to hardware/software employed to connect network interface 1738 to system bus 1708. While communication connection 1740 is shown for illustrative clarity inside computer 1702, it can also be external to computer 1702. The hardware/software for connection to network interface 1738 can include, for example, internal and external technologies such as moderns, including regular telephone grade modems, cable modems and DSL moderns, ISDN adapters, and Ethernet cards.

It is to be noted that aspects, features, or advantages of the aspects described in the subject specification can be exploited in substantially any communication technology. For example, 4G technologies, Wi-Fi, worldwide interoperability for microwave access, Enhanced gateway general packet radio service, third generation partnership project long term evolution, third generation partnership project 2 ultra mobile broadband, third generation partnership project universal mobile telecommunication system, high speed packet access, high-speed downlink packet access, high-speed uplink packet access, global system for mobile communication edge radio access network, universal mobile telecommunication system terrestrial radio access network, long term evolution advanced. Additionally, substantially all aspects disclosed herein can be exploited in legacy telecommunication technologies; e.g., global system for mobile communication. In addition, mobile as well non-mobile networks (e.g., Internet, data service network such as Internet protocol television) can exploit aspect or features described herein.

Various aspects or features described herein can be implemented as a method, apparatus, or article of manufacture using standard programming and/or engineering techniques. In addition, various aspects disclosed in the subject specification can also be implemented through program modules stored in a memory and executed by a processor, or other combination of hardware and software, or hardware and firmware.

Other combinations of hardware and software or hardware and firmware can enable or implement aspects described herein, including disclosed method(s). The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical discs (e.g., compact disc, digital versatile disc, blu-ray disc . . . ), smart cards, and flash memory devices (e.g., card, stick, key drive . . . ).

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, random access memory, read only memory, electrically erasable programmable read only memory, flash memory or other memory technology, compact disk read only memory, digital versatile disk or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What has been described above includes examples of systems and methods that provide advantages of the one or more aspects. It is, of course, not possible to describe every conceivable combination of components or methods for purposes of describing the aspects, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

As used in this application, the terms “component,” “system,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration, both an application running on a server or network controller, and the server or network controller can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software, or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. As further yet another example, interface(s) can include input/output components as well as associated processor, application, or application programming interface components.

The term “set”, “subset”, or the like as employed herein excludes the empty set (e.g., the set with no elements therein). Thus, a “set”, “subset”, or the like includes one or more elements or periods, for example. As an illustration, a set of periods includes one or more periods; a set of transmissions includes one or more transmissions; a set of resources includes one or more resources; a set of messages includes one or more messages, and so forth.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What is claimed is:

1. A system, comprising:
a memory to store instructions; and
a processor, coupled to the memory, that executes the following computer executable components stored in the memory:
a verification manager component that obtains and verifies an identity of a patient;
an instruction manager component that outputs a set of directions related to capturing a plurality of health data associated with the patient, wherein the plurality of health data relates to a remote physical examination of the patient;
a capture component that receives an indication that at least one health data of the plurality of health data is available and records the at least one health data; and
a communication component that establishes a communication link between the patient and a healthcare provider and transmits the at least one health data over the communication link, wherein the patient is located remotely from the healthcare provider.

2. The system of claim 1, wherein the instruction manager component provides the set of directions in a step wise fashion, the set of directions are related to the remote physical examination of the patient.

3. The system of claim 1, wherein the instruction manager component provides the set of directions to guide the patient to one or more auscultation sites and the capture component obtains a plurality of sounds associated with each of the one or more auscultation sites.

4. The system of claim 1, wherein the instruction manager component conveys the set of directions as a series of video displays.

5. The system of claim 1, wherein the instruction manager component conveys the set of directions through verbal commands.

6. The system of claim 1, wherein the plurality of health data comprises visual health data and audible health data.

7. The system of claim 1, wherein the capture component is paired with one or more medical devices that attain one or more health data of the plurality of health data.

8. The system of claim 1, wherein the capture component receives another indication that a subsequent health data of the plurality of health data is available and records the subsequent health data and the communication component transmits the at least one health data and the subsequent health data over the communication link at substantially the same time.

9. The system of claim 1, wherein the capture component electronically records communications between the patient and an onsite caregiver during the remote physical examination.

10. The system of claim 1, further comprising a categorization manager component that maps each of the plurality of health data to historical data associated with the patient.

11. The system of claim 1, further comprising a security management component that monitors the remote physical examination for compliance with data security and privacy issues.

12. The system of claim 1, further comprising an analysis component that reviews historical information based on keywords or phrases encountered during the remote physical examination and dynamically outputs history relevant questions.

13. A method, comprising
verifying, by a system comprising a processor, identification information indicative of an identity of a patient;
providing, by the system, a set of directions related to capturing a plurality of health data associated with the patient, wherein the plurality of health data relates to a remote physical examination of the patient;
capturing, by the system, the plurality of health data based on an indication that the plurality of health data is ready to be captured; and
communicating, by the system, the plurality of health data to a healthcare provider, wherein the healthcare provider and the patient are located in disparate locations.

14. The method of claim 13, wherein the providing comprises providing the set of directions in a step-by-step manner, the set of directions are related to the remote physical examination of the patient.

15. The method of claim 13, wherein the providing comprises providing the set of directions to guide the patient to one or more auscultation sites and the capturing comprises obtaining a plurality of sounds associated with each of the one or more auscultation sites.

16. The method of claim 13, wherein the providing comprises outputting the set of directions as a series of video displays.

17. The method of claim 13, wherein the providing comprises outputting the set of directions as verbal commands.

18. The method of claim 13, further comprising:
mapping, by the system, each of the plurality of health data to historical data associated with the patient; and
outputting, by the system, history relevant questions based on the mapping.

19. A computer-readable storage device storing computer-executable instructions that, in response to execution, cause a system comprising a processor to perform operations, comprising:
outputting a set of directions related to capturing a plurality of health data associated with a patient, wherein the plurality of health data relates to a remote physical examination of the patient;
receiving an indication that at least one health data of the plurality of health data is available;
recording the at least one health data in a visual format, an audible format, or both a visual format and an audible format;
establishing a communication link between the patient and a healthcare provider; and
transmitting the at least one health data over the communication link, wherein the patient is located remotely from the healthcare provider.

20. The computer-readable storage device of claim 19, the operations further comprising:
providing the set of directions to guide the patient to one or more auscultation sites; and
obtaining a plurality of sounds associated with each of the one or more auscultation sites.
